(19) United States
(12) Patent Application Publication
(10) Pub. No.: US 2013/0096218 A1
(43) Pub. Date: Apr. 18, 2013

(54) HEAT TRANSFER COMPOSITIONS OF HYDROFLUOROCARBONS AND A HYDROFLUOROOLEFIN

(71) Applicants: Wissam Rached, Chaponost (FR); Brett L. Van Horn, King of Prussia, PA (US); Stephen Spletzer, King of Prussia, PA (US)

(72) Inventors: Wissam Rached, Chaponost (FR); Brett L. Van Horn, King of Prussia, PA (US); Stephen Spletzer, King of Prussia, PA (US)

(73) Assignee: Arkema Inc., King of Prussia (US)

(21) Appl. No.: 13/703,061

(22) PCT Filed: Jun. 20, 2011
(86) PCT No.: PCT/US11/41051

§ 371 Date: Dec. 10, 2012

Related U.S. Application Data
(60) Provisional application No. 61/357,242, filed on Jun. 22, 2010.

(51) Int. Cl. C09K 5/00

(52) U.S. Cl. CPC C09K 5/00
USPC 521/170; 252/67; 252/68; 521/189

(57) ABSTRACT

The present invention relates to heat transfer compositions comprising 2,3,3,3-tetrafluoropropene, difluoromethane, pentafluoroethane, and 1,1,1,2-tetrafluoroethane for use in refrigeration, air-conditioning, heat pump systems, and other heat transfer applications. The inventive heat transfer compositions can possess reduced global warming potential while providing good capacity and performance.

### FIELD OF THE INVENTION

The present invention relates to heat transfer compositions comprising 2,3,3,3-tetrafluoropropene, difluoromethane, pentafluoroethane, and 1,1,1,2-tetrafluoroethane for use in refrigeration, air-conditioning, heat pump systems, and other heat transfer applications. The inventive heat transfer compositions can possess reduced global warming potential while providing good capacity and performance.

### BACKGROUND OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol.

Hydrofluorocarbons (HFC) are a leading replacement for CFCs and HCFCs in many applications. Though they are deemed “friendly” to the ozone layer they still generally possess high global warming potentials.

For instance several HFC-based refrigerants have been developed to replace R-22, an HCFC refrigerant with ozone depletion potential (ODP). These include R-404A, R-407C, R-407A, R-417A, R-422D, R-427A, R-438A, and others. However, most of the HFC-based R-22 replacements have higher global warming potential (GWP) than R-22 while also compromising in performance characteristics. For example, R-404A and R-407A may have slightly higher refrigeration capacity (CAP) than R-22 under some conditions but have lower performance (COP); R-407C has slightly lower GWP but also lower CAP and COP in refrigeration applications; many other R-22 replacements have not only a higher GWP but lower CAP and COP. FIG. 3 shows a comparison of the GWP of R-22 and several R-22 replacements.

Another limitation is that most HFCs lack the miscibility with traditional lubricants, such as mineral oils, necessary to provide adequate performance. This has resulted in the implementation of oxygenated lubricants such as polyol ester (POE) oils, polyalkylene glycol (PAG) oils, and polyvinyl ether (PVE) oils in place of mineral oils. These new lubricants can be considerably more expensive than traditional mineral oil lubricants and can be extremely hygroscopic.

Several refrigerant compositions, such as R-422D and R-438A, have been developed incorporating a small fraction of low boiling hydrocarbons, such as butanes, propanes, or pentanes, for the purposes of improving miscibility with mineral oil and thereby improving oil return. However, it has been recognized that the quantity of hydrocarbon in the refrigerant composition must be minimized to reduce the flammability of the refrigerant composition for the interest of safety, such as taught in U.S. Pat. No. 6,655,160 and U.S. Pat. No. 5,688,432.

Among the HFC products designed to replace R-22, R-407C has in particular been developed for replacing R-22 in air conditioning applications. This product is a mixture combining R-32, R-125 and R-134a in the proportions of 23/25/52% by weight. R-32 denotes difluoromethane, R-125 denotes pentafluoroethane, and R-134a denotes 1,1,1,2-tetrafluoroethane. R-407C has thermodynamic properties which are very similar to those of R-22. For this reason, R-407C can be used in old systems designed to operate with R-22, thus making it possible to replace an HCFC fluid by an HFC fluid which is safer with regards to the stratospheric ozone layer in the context of a procedure for converting these old systems. The thermodynamic properties concerned are well known to a person skilled in the art and are in particular the refrigerating capacity, the coefficient of performance (or COP) and the condensation pressure.

The refrigerating capacity represents the refrigeration power available by virtue of the refrigerant, for a given compressor. In order to replace R-22, it is essential to have available a fluid having a high refrigerating capacity close to that of R-22.

The COP expresses the ratio of the refrigerating energy delivered to the energy applied to the compressor in order to compress the refrigerant in the vapor state. In the context of the substitution of R-22, a COP value of the refrigerant which is less than that of R-22 is suitable, if an increase in the consumption of electricity of the plant is accepted.

Finally, the condensation pressure indicates the stress exerted by the refrigerant on the corresponding mechanical parts of the refrigerating circuit. A refrigerant capable of replacing R-22 in a refrigeration system designed for the latter must not exhibit a condensation pressure significantly greater than that of R-22.

In the present invention, heat transfer compositions were discovered that not only have a low GWP but have an unexpectedly good balance between capacity and performance. Preferably, the heat transfer compositions of the present invention have low flammability, more preferably the heat transfer compositions of the present invention are non-flammable, even more preferably the heat transfer compositions of the present invention are non-flammable and remain non-flammable following various leak scenarios, and even more preferably non-flammable according to ASHRAE SSPC 34. Another embodiment of the present invention are refrigerant compositions with improved oil-return characteristics in heat transfer equipment compared to the HFC refrigerants, including those incorporating small amounts of hydrocarbons such as R-422D. Though not meant to limit the scope of this invention in any way, the heat transfer compositions of the present invention are useful in new refrigeration, air conditioning, heat pump, or other heat transfer equipment; in another embodiment, the heat transfer compositions of the present invention are useful as retrofits for refrigerants in existing equipment including, but not limited to, R-22, R-407C, R-427A, R-404A, R-407A, R-417A, R-422D, and others.

### BRIEF DESCRIPTION OF THE DRAWINGS

FIG. 1 is a graph of Capacity (CAP) versus Box Temperature

FIG. 2 is a graph of Coefficient of Performance (COP) versus Box Temperature

FIG. 3 is a chart of Global Warming Potential for a variety of materials.

### DETAILED DESCRIPTION OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications; though they are deemed “friendly” to the ozone layer they still generally possess high global warming potentials. One new class of compounds that has been identified to replace ozone depleting or high global warming substances are halogenated olefins, such as hydrofluoroolefins (HFO) and hydrochlorofluoroolefins (HCFO).

The heat transfer compositions of the present invention are comprised of difluoromethane (R-32), pentafluoroethane (R-125), 2,3,3,3-tetrafluoropropene (R-1234yf), and 1,1,1,2-tetrafluoroethane (R-134a).

In an embodiment of the present invention, the heat transfer compositions of the present invention are comprised of from about 1% to 97% R-32, from about 1% to 97% R-125, from about 1% to 97% R-1234yf, and from about 1% to 97% R-134a by weight. In another embodiment of the present invention, the heat transfer composition of the present invention comprises from about 10% to 35% R-32, from about 10% to 35% R-125, from about 10% to 60% R-1234yf and from about 10% to 60% R-134a on a weight basis. In another embodiment of the present invention, the heat transfer composition of the present invention comprises from about 15% to 30% R-32, from about 15% to 30% R-125, from about 15% to 40% R-1234yf and from about 15% to 40% R-134a on a weight basis.

In another embodiment of the present invention, the heat transfer compositions of the present invention comprise less than about 40 wt % R-125, preferably less than about 30 wt % R-125, and greater than about 10 wt % R-1234yf, preferably greater than about 20 wt % R-1234yf. In an embodiment of the present invention, the heat transfer compositions of the present invention are comprised of R-32, R-125, R-1234yf, and R-134a wherein the wt % of R-32 is from about 5% to 40% by weight, preferably from about 10% to 30% by weight, and greater than about 10 wt % R-1234yf, preferably greater than about 20 wt % R-1234yf.

In an embodiment of the present invention, the heat transfer compositions are comprised of R-32, R-125, R-1234yf, and R-134a wherein the combined wt % of R-32 and R-125 is from 2% to 98% and the combined wt % of R-134a and R-1234yf is from about 98% to 2%; preferably the combined wt % of R-32 and R-125 is from about 25% to 70% and the combined wt % of R-134a and R-1234yf is from about 75% to 30%.; more preferably the combined wt % of R-32 and R-125 is from about 35% to 60% and the combined wt % of R-134a and R-1234yf is from about 65% to 40%; and even more preferably where the combined wt % of R-32 and R-125 is from about 45% to about 60% and the combined wt % of R-134a and R-1234y is from about 55% to 40%.

In another embodiment of the present invention, the heat transfer compositions of the present invention are comprised of from about 20% to 30% by weight R-32, from 25% to 40% by weight R-125, greater than 5% by weight R-1234yf, and where the ratio of R-134a to R-1234yf is from 1:3 or greater.

In an embodiment of the present invention, the heat transfer compositions of the present invention are comprised of R-32, R-125, R-1234yf, and R-134a wherein the ratio of R-125 to R-32 by weight is from about 1:2 to about 2:1, preferably from about 1:2 to about 1:1. In another embodiment of the present invention, the heat transfer compositions of the present invention are comprised of R-32, R-125, R-1234yf, and R-134a wherein the ratio of R-125 to R-32 by weight is from about 1.4:1 to about 2:1 In another embodiment of the present invention, the heat transfer compositions of the present invention are comprised of R-32, R-125, R-1234yf, and R-134a wherein the ratio of R-134a to R-1234yf by weight is from about 1:2 to about 2:1.

The heat transfer compositions of the present invention can be used to replace existing refrigerants, particularly those with a higher ozone depletion potential (ODP) or higher global warming potential (GWP). In an embodiment, the heat transfer compositions of the present invention can be used to replace R-134a, preferably where the heat transfer composition of the present invention comprises less than about 20 wt % R-32, more preferably less than about 15 wt % R-32, more preferably less than about 10% R-32, and even more preferably between about 2 wt % and 10 wt % R-32;

and less than about 20 wt % R-125, more preferably less than about 15 wt % R-125, more preferably less than about 10% R-125, and even more preferably between about 2 wt % and 10 wt % R-125. In an embodiment, the heat transfer compositions of the present invention can be used to replace R-410A, preferably where the heat transfer composition of the present invention comprises greater than about 40 wt % R-32, more preferably greater than about 50 wt % R-32, more preferably greater than about 60% R-32, and even more preferably greater than about 80 wt % R-32. In an embodiment, the heat transfer compositions of the present invention can be used to replace R-22 or R-404A, preferably where the heat transfer composition of the present invention comprises between about 10 wt % and 50 wt % R-32, more preferably between about 10 wt % and 30 wt % R-32.

In an embodiment of the present invention, the heat transfer compositions of the present invention comprise from 5 wt % to 40 wt % R-32, from 5 wt % to 40 wt % R-125, from 5 wt % to 60 wt % R-134a, and from 5 wt % to 75 wt % R-1234yf; preferably where the combined total of R1234yf and R-134a is from 30 wt % to 80 wt %. In another embodiment of the present invention, these heat transfer compositions are particularly useful as replacements for R-22.

In an embodiment of the present invention, the heat transfer compositions of the present invention comprise from 5 wt % to 10 wt % R-32, from 5 wt % to 40 wt % R-125, from 5 wt % to 60 wt % R-134a, and from 5 wt % to 85 wt % R-1234yf; preferably where the combined total of R1234yf and R-134a is from 60 wt % to 90 wt %. In another embodiment of the present invention, these heat transfer compositions are particularly useful as replacements for R-134a.

In an embodiment of the present invention, the heat transfer compositions of the present invention comprise from 65 wt % to 85 wt % R-32, from 5 wt % to 20 wt % R-125, from 5 wt % to 20 wt % R-134a, and from 5 wt % to 25 wt % R-1234yf; preferably where the combined total of R1234yf and R-134a is from 10 wt % to 30 wt %. In another embodiment of the present invention, these heat transfer compositions are particularly useful as replacements for R-410A.

Flammability is an important property for many applications where it is very important or essential for the composition to be non-flammable, including particularly refrigerant and heat transfer applications. There are various methods of measuring the flammability of compounds and compositions, such as by measuring flash point or by ASTM E 681-01 as specified by ASHRAE Addendum 34p-92, as applicable. Preferably, the non-flammable compositions are non-flammable at ambient temperature and lower, preferably are non-flammable at 60° C. and lower, and even more preferably are non-flammable at 100° C. and lower. A greater range for non-flammability is beneficial by providing a greater degree of safety during use, handling, or transport.

In a preferred embodiment of the present invention, the heat transfer compositions of the present invention are non-flammable. Preferably, the heat transfer composition of the present invention is non-flammable and remains non-flammable upon fractionation between a liquid and vapor phase. For example, in a 50% leak test a vessel is charged with an initial composition, which is preferably non-flammable. The vessel can be maintained at a desired temperature, such as −25° C. or 25° C., and the initial vapor phase composition is measured, and is preferably non-flammable. The composition is allowed to leak from the vessel at constant temperature and set leak rate until 50% by weight of the initial composition is removed, at which time the final vapor phase composition is measured, and is preferably non-flammable.

In a preferred embodiment of the present invention, the heat transfer compositions of the present invention exhibit minimal change in composition or vapor pressure following a leak of the heat transfer composition from a vessel or equipment.

In one such leak case, the heat transfer composition of the present invention is charged to a vessel and maintained at constant temperature. The heat transfer composition is permitted to leak from the vessel at a slow rate until 50% by weight of the overall composition has escaped the vessel. In a preferred embodiment of the present invention, the vapor pressure of the heat transfer composition will not have significantly changed following the 50% leak; preferably the vapor pressure has changed less than 20%, more preferably less than 10%, more preferably less than 5%, and even more preferably less than 2%. In another embodiment of the present invention, the vapor and liquid phases in the vessel following the 50% leak are non-flammable.

Though not meant to limit the scope of the present invention in any way, examples of heat transfer compositions of the present invention for use as replacements for R-22 and R-404A are shown in Table 1.

TABLE 1

| R-32 | R-125 | R-1234yf | R-134a | GWP |
|---|---|---|---|---|
| (wt %) | (wt %) | (wt %) | (wt %) | (wt %) |
| 23 | 25 | 22 | 30 | 1460 |
| 21 | 25 | 22 | 32 | 1475 |
| 30 | 30 | 15 | 25 | 1611 |
| 20 | 25 | 23 | 32 | 1469 |
| 15 | 15 | 30 | 40 | 1199 |
| 15 | 15 | 35 | 35 | 1128 |
| 15 | 25 | 25 | 35 | 1478 |
| 15 | 25 | 30 | 30 | 1406 |
| 15 | 30 | 25 | 30 | 1581 |
| 15 | 35 | 20 | 30 | 1756 |
| 20 | 15 | 30 | 35 | 1162 |
| 20 | 20 | 30 | 30 | 1265 |
| 20 | 25 | 25 | 30 | 1440 |
| 20 | 30 | 20 | 30 | 1615 |
| 20 | 40 | 20 | 20 | 1822 |
| 20 | 40 | 15 | 25 | 1893 |
| 25 | 25 | 25 | 25 | 1402 |
| 25 | 30 | 20 | 25 | 1577 |
| 30 | 30 | 20 | 20 | 1539 |
| 30 | 30 | 15 | 25 | 1611 |
| 30 | 35 | 15 | 20 | 1714 |
| 43 | 2 | 15 | 40 | 933 |
| 19 | 24 | 24 | 33 | 1441 |
| 30.7 | 30 | 18.4 | 20.9 | 1557 |

Though not meant to limit the scope of this invention in any way, examples of heat transfer compositions of the present invention for use as replacements for R-22 are shown in Table 2.

TABLE 2
R-22 Replacements

| R-32 | R-125 | R-1234yf | R-134a | |
|---|---|---|---|---|
| (wt %) | (wt %) | (wt %) | (wt %) | GWP |
| 15 | 5 | 75 | 5 | 351 |
| 15 | 10 | 70 | 5 | 526 |
| 15 | 15 | 65 | 5 | 700 |
| 15 | 20 | 60 | 5 | 875 |
| 15 | 25 | 55 | 5 | 1050 |
| 15 | 30 | 50 | 5 | 1225 |
| 15 | 35 | 45 | 5 | 1400 |
| 15 | 40 | 40 | 5 | 1574 |
| 15 | 5 | 65 | 15 | 493 |
| 15 | 10 | 60 | 15 | 668 |
| 15 | 15 | 55 | 15 | 843 |
| 15 | 20 | 50 | 15 | 1018 |
| 15 | 25 | 45 | 15 | 1193 |
| 15 | 30 | 40 | 15 | 1367 |
| 15 | 5 | 55 | 25 | 636 |
| 15 | 10 | 50 | 25 | 811 |
| 15 | 15 | 45 | 25 | 986 |
| 25 | 5 | 65 | 5 | 418 |
| 25 | 10 | 60 | 5 | 593 |
| 25 | 15 | 55 | 5 | 767 |
| 25 | 20 | 50 | 5 | 942 |
| 25 | 25 | 45 | 5 | 1117 |
| 25 | 30 | 40 | 5 | 1292 |
| 25 | 35 | 35 | 5 | 1467 |
| 25 | 40 | 30 | 5 | 1641 |
| 25 | 5 | 55 | 15 | 560 |
| 25 | 10 | 50 | 15 | 735 |
| 25 | 15 | 45 | 15 | 910 |
| 25 | 20 | 40 | 15 | 1085 |
| 25 | 25 | 35 | 15 | 1260 |
| 25 | 30 | 30 | 15 | 1434 |
| 25 | 35 | 25 | 15 | 1609 |
| 25 | 5 | 45 | 25 | 703 |
| 25 | 10 | 40 | 25 | 878 |
| 25 | 15 | 35 | 25 | 1053 |
| 25 | 20 | 30 | 25 | 1227 |
| 25 | 25 | 25 | 25 | 1402 |
| 25 | 30 | 20 | 25 | 1577 |
| 25 | 35 | 15 | 25 | 1752 |
| 25 | 5 | 35 | 35 | 846 |
| 25 | 10 | 30 | 35 | 1020 |
| 25 | 15 | 25 | 35 | 1195 |
| 25 | 20 | 20 | 35 | 1370 |
| 25 | 25 | 15 | 35 | 1545 |
| 25 | 30 | 10 | 35 | 1720 |
| 25 | 35 | 5 | 35 | 1894 |
| 25 | 5 | 25 | 45 | 988 |
| 25 | 10 | 20 | 45 | 1163 |
| 25 | 15 | 15 | 45 | 1338 |
| 25 | 20 | 10 | 45 | 1513 |
| 25 | 25 | 5 | 45 | 1687 |
| 25 | 5 | 10 | 60 | 1202 |
| 40 | 5 | 50 | 5 | 519 |
| 40 | 10 | 45 | 5 | 693 |
| 40 | 15 | 40 | 5 | 868 |
| 40 | 20 | 35 | 5 | 1043 |
| 40 | 25 | 30 | 5 | 1218 |
| 40 | 5 | 40 | 15 | 661 |
| 40 | 10 | 35 | 15 | 836 |
| 40 | 15 | 30 | 15 | 1011 |
| 40 | 20 | 25 | 15 | 1186 |
| 40 | 25 | 20 | 15 | 1360 |
| 40 | 30 | 15 | 15 | 1535 |
| 40 | 5 | 30 | 25 | 804 |
| 40 | 10 | 25 | 25 | 979 |
| 40 | 15 | 20 | 25 | 1153 |
| 40 | 20 | 15 | 25 | 1328 |
| 40 | 25 | 10 | 25 | 1503 |
| 40 | 30 | 5 | 25 | 1678 |
| 40 | 5 | 20 | 35 | 946 |
| 40 | 10 | 15 | 35 | 1121 |
| 40 | 15 | 10 | 35 | 1296 |
| 40 | 20 | 5 | 35 | 1471 |
| 40 | 5 | 10 | 45 | 1089 |
| 40 | 10 | 5 | 45 | 1264 |

Though not meant to limit the scope of this invention in any way, examples of heat transfer compositions of the present invention for use as replacements for R-134a are shown in Table 3.

TABLE 3
R-134a Replacements

| R-32 | R-125 | R-1234yf | R-134a | |
|---|---|---|---|---|
| (wt %) | (wt %) | (wt %) | (wt %) | GWP |
| 5 | 5 | 85 | 5 | 284 |
| 5 | 10 | 80 | 5 | 458 |
| 5 | 15 | 75 | 5 | 633 |
| 5 | 20 | 70 | 5 | 808 |
| 5 | 25 | 65 | 5 | 983 |
| 5 | 30 | 60 | 5 | 1158 |
| 5 | 35 | 55 | 5 | 1332 |
| 5 | 5 | 75 | 15 | 426 |
| 5 | 10 | 70 | 15 | 601 |
| 5 | 15 | 65 | 15 | 776 |
| 5 | 20 | 60 | 15 | 951 |
| 5 | 25 | 55 | 15 | 1125 |
| 5 | 30 | 50 | 15 | 1300 |
| 5 | 5 | 70 | 20 | 1211 |
| 5 | 10 | 65 | 20 | 1314 |
| 5 | 15 | 60 | 20 | 1418 |
| 5 | 20 | 55 | 20 | 1521 |
| 5 | 25 | 50 | 20 | 1625 |
| 5 | 30 | 45 | 20 | 1728 |
| 5 | 5 | 65 | 25 | 569 |
| 5 | 10 | 60 | 25 | 744 |
| 5 | 15 | 55 | 25 | 918 |
| 5 | 20 | 50 | 25 | 1093 |
| 5 | 25 | 45 | 25 | 1268 |
| 5 | 5 | 55 | 35 | 711 |
| 5 | 10 | 50 | 35 | 886 |
| 5 | 15 | 45 | 35 | 1061 |
| 5 | 20 | 40 | 35 | 1236 |
| 5 | 5 | 45 | 45 | 854 |
| 5 | 10 | 40 | 45 | 1029 |
| 5 | 15 | 35 | 45 | 1204 |
| 5 | 20 | 30 | 45 | 1378 |
| 5 | 5 | 30 | 60 | 1068 |
| 5 | 10 | 25 | 60 | 1243 |

Though not meant to limit the scope of this invention in any way, examples of heat transfer compositions of the present invention for use as replacements for R-410A are shown in Table 4.

TABLE 4
R-410A Replacements

| R-32 | R-125 | R-1234yf | R-134a | |
|---|---|---|---|---|
| (wt %) | (wt %) | (wt %) | (wt %) | GWP |
| 70 | 5 | 20 | 5 | 720 |
| 70 | 10 | 15 | 5 | 895 |
| 70 | 15 | 10 | 5 | 1069 |
| 70 | 20 | 5 | 5 | 1244 |
| 70 | 5 | 15 | 10 | 791 |
| 70 | 10 | 10 | 10 | 966 |
| 70 | 5 | 10 | 15 | 862 |
| 70 | 10 | 5 | 15 | 1037 |
| 70 | 5 | 5 | 20 | 934 |
| 85 | 5 | 5 | 5 | 820 |

An embodiment of the present invention are heat transfer compositions that have a low glide, preferably where the glide is <10° C., more preferably where the glide is <5° C.

Compositions of the present invention may be azeotropic or quazi-azeotropic. A quazi-azeotropic composition (also referred to as an “azeotrope-like” or “near-azeotrope”) is a substantially constant boiling liquid mixture of two or more substances that behaves essentially as a single substance. One way to characterize a quazi-azeotropic composition is that a vapor in equilibrium with a liquid have substantially the same composition, such as if the vapor produced by distillation or partial evaporation of the liquid has substantially the same composition as the liquid. Another way to characterize a quazi-azeotropic composition is that the saturated liquid pressure and the saturated vapor pressure are substantially the same at the same at a given temperature.

Though not meant to limit the scope of the present invention in any way, examples of quazi-azeotropic heat transfer compositions of the present invention are shown in Table 5, which shows the percent difference between the saturated liquid and saturated vapor pressures at −30°. In a preferred embodiment, the quazi-azeotropic compositions can be used as replacements for R-410A.

TABLE 5
Quazi-azeotrope blends

| | | | | | P Sat. | P Sat. | |
|---|---|---|---|---|---|---|---|
| R-32 | R-125 | R-1234yf | R-134a | T | Liq. | Vap. | |
| (wt %) | (wt %) | (wt %) | (wt %) | (° C.) | (bar) | (bar) | %-Diff |
| 70 | 5 | 20 | 5 | −30 | 2.6 | 2.4 | 6% |
| 70 | 10 | 15 | 5 | −30 | 2.6 | 2.5 | 6% |
| 70 | 15 | 10 | 5 | −30 | 2.6 | 2.5 | 5% |
| 70 | 20 | 5 | 5 | −30 | 2.7 | 2.5 | 4% |
| 70 | 5 | 15 | 10 | −30 | 2.6 | 2.4 | 9% |
| 70 | 10 | 10 | 10 | −30 | 2.6 | 2.4 | 8% |
| 85 | 5 | 5 | 5 | −30 | 2.7 | 2.6 | 4% |

In an embodiment of the present invention are quazi-azeotropic compositions with from 65 to 75 wt % R-32, 5 to 20 wt % R-125, 5 to 20 wt % R-1234yf, and 5 to 10 wt % 134a. In another embodiment of the present invention are quazi-azeotropic compositions with about 70 wt % R-32, 5 to 20 wt % R-125, 5 to 20 wt % R-1234yf, and 5 to 10 wt % 134a. In a another embodiment of the present invention are quazi-azeotropic compositions with from 85 to 97 wt % R-32, 1 to 5 wt % R-125, 1 to 5 wt % R-1234yf, and 1 to 5 wt % 134a.

An embodiment of the present invention are heat transfer compositions with a low GWP value, preferably where the GWP is less than 2000, more preferably less than 1500, more preferably<1400, and even more preferably<1000.

An embodiment of the present invention are heat transfer compositions that when used in refrigeration, air-conditioning, or heat pump systems provide similar or better capacity, performance, or both than HFC or HCFC based refrigerants used in similar applications.

The heat transfer compositions of the present invention may be used in combination with a lubricating oil. Exemplary lubricating oils include polyol esters, polyalkylene glycols, polyglycols, polyvinyl ethers, mineral oils, alkyl benzene oil, polyalpha olefins, and mixtures thereof. Lubricating oils of the present invention range from very low to high viscosity, preferably with viscosities at 100° F. from 15 to 800 cSt, and more preferably from 20 to 100 cSt. The typical refrigeration lubricating oils used in the present invention had viscosities of 15, 32, 68, and 100 cSt at 100° F.

The following is a exemplary description of polyol ester (POE) lubricating oils and is not meant to limit the scope of the present invention in any way. POE oils are typically formed by a chemical reaction (esterification) of a carboxylic acid, or mixture of carboxylic acids, with an alcohol, or mixtures of alcohols. The carboxylic acids are typically mono-functional or di-functional. The alcohols are typically mono-functional or poly-functional (polyols). The polyols are typically di-, tri-, or tetra-functional. Examples of polyols include, but are not limited to, neopentylglycol, glycerin, trimethylolpropane, pentaerythritol, and mixtures thereof Examples of carboxylics acids include, but are not limited to, ethyl hexanoic acid, including 2-ethyl hexanoic acid, trimethyl hexanoic acid, including 3,5,5-trimethyl hexanoic acid, octanoic acid, including linear octanoic acid, pentanoic acid, including n-pentanoic acid, neo acids, including dimethylpentanoic acid, C5 to C20 carboxylic acids, and mixtures thereof The carboxylic acids may also be derived from natural sources, including, but not limited to, plant and vegetable oils of soybean, palm, olive, rapeseed, cottonseed, coconut, palm kernal, corn, castor, sesame, jojoba, peanut, sunflower, others, and mixtures thereof. Natural oil carboxylic acids are typically C18 acids but also include C12-C20 acids, among others. In one embodiment of the present invention, the POE oil is formulated using one or more mono-functional carboxylic acid with one or more polyol. In one embodiment of the present invention, the POE oil is formulated using one or more di-functional carboxylic acid with one or more mono-functional alcohol. In one embodiment of the present invention, the POE oil is a mixture of different POE oils. In one embodiment of the present invention, the POE oil is formulated using one or more C5-C10 carboxylic acids. Hydrocarbon lubricating oils of the present invention may comprise those commonly known as “mineral oils” in the field of compression refrigeration lubrication. Mineral oils comprise paraffins (i.e. straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). Hydrocarbon lubricating oils of the present invention further comprise those commonly known as “synthetic oils” in the field of compression refrigeration lubrication. Synthetic oils comprise alkylaryls (i.e. linear and branched alkyl alkylbenzenes), synthetic paraffins and napthenes, and poly(alphaolefins).

Traditional classification of oils as paraffinic or naphthenic refers to the number of paraffinic or naphthenic molecules in the refined lubricant. Paraffinic crudes contain a higher proportion of paraffin wax, and thus have a higher viscosity index and pour point than to naphthenic crudes.

Alkylbenzene lubricating oils have alkyl side chains that are either branched or linear, with a distribution in chain lengths typically from 10 to 20 carbons, though other alkyl chain length distributions are possible. Another preferred alkylbenzene lubricating oil comprises at least one alkylbenzene of the form: (C₆H₆)—C(CH₂)(R₁)(R₂) where (C₆H₆) is a benzyl ring and R₁ and R₂ are saturated alkyl groups, preferably containing at least one isoC₃ group, more preferably from 1 to 6 isoC₃ groups. Either R₁ or R₂ may be a hydrogen atom, but preferably not both.

PAG oils can be ‘un-capped’, ‘single-end capped’, or ‘double-end capped’. Examples of commercial PAG oils include, but are not limited to, ND-8, Castrol PAG 46, Castrol PAG 100, Castrol PAG 150, Daphne Hermetic PAG PL, Daphne Hermetic PAG PR.

Polyvinyl ether (PVE) oils are another type of oxygenated refrigeration oil that has been developed for use with HFC refrigerants. Commercial examples of PVE refrigeration oil include FVC32D and FVC68D produced by Idemitsu. Though not meant to limit the scope of the present invention in any way, in an embodiment of the present invention, the polyvinyl ether oil includes those taught in the literature such as described in U.S. Pat. Nos. 5,399,631 and 6,454,960. In another embodiment of the present invention, the polyvinyl ether oil is composed of structural units of the type shown by Formula 1:

—[C(R₁,R₂)—C(R₃,—O—R₄)]— Formula 1

Where R₁, R₂, R₃, and R₄ are independently selected from hydrogen and hydrocarbons, where the hydrocarbons may optionally contain one or more ether groups. In a preferred embodiment of the present invention, R₁, R₂ and R₃ are each hydrogen, as shown in Formula 2:

—[CH₂—CH(—O—R₄)]— Formula 2

In another embodiment of the present invention, the polyvinyl ether oil is composed of structural units of the type shown by Formula 3:

—[CH₂—CH(—O—R₅)]ₘ-[CH₂—CH(—O—R₆)]ₙ- Formula 3

Where R₅ and R₆ are independently selected from hydrogen and hydrocarbons and where m and n are integers.

The thermal/chemical stability of refrigerant/lubricant mixtures can be evaluated using various tests known to those of skill the art, such as ANSI/ASHRAE Standard 97-2007 (ASHRAE 97). In such a test, mixtures of refrigerant and lubricant, optionally in the presence of catalyst or other materials including water, air, metals, metal oxides, ceramics, etc, are typically aged at elevated temperature for a predetermined aging period. After aging the mixture is analyzed to evaluate any decomposition or degradation of the mixture. A typical composition for testing is a 50/50 wt/wt mixture of refrigerant/lubricant, though other compositions can be used. Typically, the aging conditions are at from about 140° C. to 200° C. for from 1 to 30 days; aging at 175° C. for 14 days is very typical.

Multiple techniques are typically used to analyze the mixtures following aging. A visual inspection of the liquid fraction of the mixture for any signs of color change, precipitation, or heavies, is used to check for gross decomposition of either the refrigerant or lubricant. Visual inspection of any metal test pieces used during testing is also done to check for signs of corrosion, deposits, etc. Halide analysis is typically performed on the liquid fraction to quantify the concentration of halide ions (eg. fluoride) present. An increase in the halide concentration indicates a greater fraction of the halogenated refrigerant has degraded during aging and is a sign of decreased stability. The Total Acid Number (TAN) for the liquid fraction is typically measured to determine the acidity of the recovered liquid fraction, where an increase in acidity is a sign of decomposition of the refrigerant, lubricant, or both. GC-MS is typically performed on the vapor fraction of the sample to identify and quantify decomposition products.

The effect of water on the stability of the refrigerant/lubricant combination can be evaluated by performing the aging tests at various levels of moisture ranging from very dry (<10 ppm water) to very wet (>10000 ppm water). Oxidative stability can be evaluated by performing the aging test either in the presence or absence of air. The heat transfer compositions of the present invention may be used in combination with other refrigerants such as hydrofluorocarbons, hydrochlorofluorocarbons, hydrofluoroolefins, hydrofluorochlorocarbons, hydrocarbons, hydrofluoroethers, fluoroketones, chlorofluorocarbons, trans-1,2-dichloroethylene, carbon dioxide, ammonia, dimethyl ether, propylene, and mixtures thereof.

Exemplary hydrofluorocarbons (HFCs) include difluoromethane (HFC-32); 1-fluoroethane (HFC-161); 1,1-difluoroethane (HFC-152a); 1,2-difluoroethane (HFC-152); 1,1,1-trifluoroethane (HFC-143a); 1,1,2-trifluoroethane (HFC-143); 1,1,1,2-tetrafluoroethane (HFC-134a); 1,1,2,2-tetrafluoroethane (HFC-134); 1,1,1,2,2-pentafluoroethane (HFC-125); 1,1,1,3,3-pentafluoropropane (HFC-245fa); 1,1,2,2,3-pentafluoropropane (HFC-245ca); 1,1,1,2,3-pentafluoroproparie (HFC-245eb); 1,1,1,3,3,3-hexafluoropropane (HFC-236fa); 1,1,1,2,3,3,3-heptafluoropropane (HFC-227ea); 1,1,1,3,3-pentafluorobutane (HFC-365mfc), 1,1,1,2,3,4,4,5,5,5-decafluoropropane (HFC-4310), and mixtures thereof. Preferred hydrofluorocarbons include HFC-134a, HFC-32, HFC-152a, HFC-125, and mixtures thereof.

Exemplary hydrofluoroolefins (HFOs) include 3,3,3-trifluoropropene (HFO-1234zf), 1,3,3,3-tetrafluoropropene (HFO-1234ze), particularly the E-isomer, 2,3,3,3-tetrafluoropropene (HFO-1234yf), 1,2,3,3,3-pentafluoropropene (HFO-1255ye), particularly the Z-isomer, E-1,1,1,3,3,3-hexafluorobut-2-ene (E-HFO-1336mzz), Z-1,1,1,3,3,3-hexafluorobut-2-ene (Z-HFO-1336mzz), 1,1,1,4,4,5,5,5-octafluoropent-2-ene (HFO-1438mzz) and mixtures thereof. Preferred hydrofluoroolefins include 3,3,3-trifluorpropene (HFO-12344, E-1,3,3,3-tetrafluoropropene (HFO-1234ze), 2,3,3,3-tetrafluoropropene (HFO-1234yf), and mixtures thereof.

Exemplary hydrochlorofluoroolefins (HCFOs) include 1-chloro-3,3,3-trifluoropropene (HCFO-1233zd), particularly the trans-isomer, 2-chloro-3,3,3-trifluoropropene (HCFO-1233xf), and dichloro-tetrafluoropropenes, such as isomers of HCFO-1214.

Exemplary hydrocarbons (HCs) include propylene, propane, butane, isobutane, n-pentane, iso-pentane, neo-pentane, cyclopentane, and mixtures thereof. Preferred hydrocarbons include propylene, propane, butane, and iso-butane.

Exemplary hydrochlorofluorocarbons (HCFCs) include chloro-difluoromethane (HCFC-22), 1-chloro-1,1-difluoroethane (HCFC-142b), 1,1-dichloro-1-fluoroethane (HCFC-141b), 1,1-dichloro-2,2,2-trifluoroethane (HCFC-123), and 1-chloro-1,2,2,2-tetrafluoroethane (HCFC-124).

Exemplary chlorofluorocarbons (CFCs) include trichlorofluoromethane (R-11), dichlorodifluoromethane (R-12), 1,1,2-trifluoro-1,2,2-trifluoroethane (R-113), 1,2-dichloro-1,1,2,2-tetrafluoroethane (R-114), chloro-pentafluoroethane (R-115) and mixtures thereof.

Exemplary hydrofluoroethers (HFEs) include 1,1,1,2,2,3,3-heptafluoro-3-methoxy-propane, 1,1,1,2,2,3,3,4,4-nonafluoro-4-methoxy-butane and mixtures thereof.

An exemplary fluoroketone is 1,1,1,2,2,4,5,5,5-nonafluoro-4(trifluoromethyl)-3-pentanone.

The heat transfer compositions of the present invention may be used in combination with dyes, stabilizers, acid scavengers, antioxidant, viscosity modifiers, pour point depressants, corrosion inhibitors, nanoparticles, surfactants, compatibilizers, solubilizing agents, dispersing agents, fire retarding agents, flame suppressants, medicants, sterilants, polyols, polyol premix components, cosmetics, cleaners, flushing agents, anti-foaming agents, oils, odorants, tracer compounds, and mixtures thereof.

The heat transfer compositions of the present invention may be used in heat transfer systems, including for refrigeration, air conditioning, and liquid chilling. Heat transfer systems are operated with one portion of the cycle at a the lower operating temperature range and another part of the cycle at the upper operating temperature range. These upper and lower temperature ranges will depend on the specific application. For example, the operating temperatures for low temperature refrigeration may be different than for automotive air conditioning or for water chillers. Preferrably, the upper operating temperature range is from about +15° C. to about +90° C., more preferrably from about +30° C. to about +70° C. Preferrably, the lower operating temperature range is from about +25° C. to about −60° C., more preferrably from about +15° C. to about −30° C. For example, a low pressure liquid chiller may be operated at an evaporator temperature from about −10° C. to +10° C. and a condensor temperature from about +30° C. to +55° C. For example, an air conditioner, such as for automotive AC, may operate with an evaporating temperature at 4° C. and a condensing temperature of 40° C. For refrigeration, the lower operating temperature range may be dependant upon the specific application. For instance, some typical application temperatures for refrigeration include: freezer (eg. ice cream): −15° F. +/−2° F. (−26° C. +/−1.1° C.); low temperature: 0° F. +/−2° F. (−18° C. +/−1.1° C.); medium temperature: 38° F. +/−2° F. (3.3° C. +/−1.1° C.). These examples are only informative and not meant to limit the scope of the present invention in any way.

Other operating temperatures and operating temperature ranges may be employed within the scope of the present invention.

The heat transfer compositions of the present invention are also useful in organic Rankine cycles for electricity production.

Though not meant to limit the scope of this invention in any way, the heat transfer compositions of the present invention are useful in new refrigeration, air conditioning, heat pump, or other heat transfer equipment; in another embodiment, the heat transfer compositions of the present invention are useful as retrofits for refrigerants in existing equipment including, but not limited to, R-22, R-407C, R-427A, R-404A, R-407A, R-417A, R-422D, and others. When the heat transfer compositions of the present invention are used as retrofits for other refrigerants in existing equipment, it is preferred that the operating characteristic, such as pressures, discharge temperature, mass flow rate, are similar to the operating characteristics of the refrigerant being replaced. In a higherly preferred embodiment, the heat transfer compositions of the present invention have operating characteristics that are close enough to the refrigerant being replaced to avoid the need to change make additional changes to the equipment, such as changing a thermal expansion valve (TXV).

### Methods and Systems

The compositions of the present invention are useful in connection with numerous methods and systems, including as heat transfer fluids in methods and systems for transferring heat, such as refrigerants used in refrigeration, air conditioning and heat pump systems. The present compositions are also advantageous for in use in systems and methods of generating aerosols, preferably comprising or consisting of the aerosol propellant in such systems and methods. Methods of forming foams and methods of extinguishing and suppressing fire are also included in certain aspects of the present invention. The present invention also provides in certain aspects methods of removing residue from articles in which the present compositions are used as solvent compositions in such methods and systems.

### Heat Transfer Methods

The preferred heat transfer methods generally comprise providing a composition of the present invention and causing heat to be transferred to or from the composition changing the phase of the composition. For example, the present methods provide cooling by absorbing heat from a fluid or article, preferably by evaporating the present refrigerant composition in the vicinity of the body or fluid to be cooled to produce vapor comprising the present composition. Preferably the methods include the further step of compressing the refrigerant vapor, usually with a compressor or similar equipment to produce vapor of the present composition at a relatively elevated pressure. Generally, the step of compressing the vapor results in the addition of heat to the vapor thus causing an increase in the temperature of the relatively high-pressure vapor. Preferably, the present methods include removing from this relatively high temperature, high pressure vapor at least a portion of the heat added by the evaporation and compression steps. The heat removal step preferably includes condensing the high-temperature, high-pressure vapor while the vapor is in a relatively high-pressure condition to produce a relatively high-pressure liquid comprising a composition of the present invention. This relatively high-pressure liquid preferably then undergoes a nominally isoenthalpic reduction in pressure to produce a relatively low temperature, low-pressure liquid. In such embodiments, it is this reduced temperature refrigerant liquid which is then vaporized by heat transferred from the body or fluid to be cooled.

In another process embodiment of the invention, the compositions of the invention may be used in a method for producing heating which comprises condensing a refrigerant comprising the compositions in the vicinity of a liquid or body to be heated. Such methods, as mentioned hereinbefore, frequently are reverse cycles to the refrigeration cycle described above.

The heat transfer combinations of the present invention are effective working fluids in refrigeration, air-conditioning, or heat pump systems. Typical vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows: liquid refrigerant enters an evaporator through an expansion device, and the liquid refrigerant boils in the evaporator at a low temperature to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

The heat transfer combinations of the present invention are useful in mobile or stationary systems. Stationary air-conditioning and heat pumps include, but are not limited to chillers, high temperature heat pumps, residential and light commercial and commercial air-conditioning systems. Stationary refrigeration applications include, but are not limited to, equipment such as domestic refrigerators, ice machines, walk-in and reach-in coolers and freezers, and supermarket systems. As used herein, mobile refrigeration systems or mobile air-conditioning systems refers to any refrigeration or air-conditioning apparatus incorporated into a transportation unit for the road, rail, sea or air. The present invention is particularly useful for road transport refrigerating or air-conditioning apparatus, such as automobile air-conditioning apparatus or refrigerated road transport equipment.

Typical compressors used in refrigeration, air-conditioning, or heat pump systems are positive-displacement and dynamic compressors. Positive-displacement compressors include reciprocating compressors, such as piston compressors, orbiting compressors, such as scroll compressors, and rotary compressors, such as screw compressors. A typical dynamic compressor is a centrifugal compressor. The heat transfer compositions of the present invention can be used in heat transfer equipment employing any of these compressor types.

Refrigeration, air-conditioning, or heat pump systems may use single-staged, double-staged, or multi-staged compression. Refrigeration, air-conditioning, or heat pump systems may also be cascade systems with or without a secondary heat transfer circuit.

Heat exchangers used in the heat transfer systems may be of any type. Typical heat exchangers include parallel or co-current flow, counterflow, cross-flow. Preferably, heat exchangers used with the heat transfer compositions of the present invention are counterflow, counterflow-like, or crossflow.

### Propellant and Aerosol Compositions

In another aspect, the present invention provides propellant compositions comprising or consisting essentially of a composition of the present invention, such propellant composition preferably being a sprayable composition. The propellant compositions of the present invention preferably comprise a material to be sprayed and a propellant comprising, consisting essentially of, or consisting of a composition in accordance with the present invention. Inert ingredients, solvents, and other materials may also be present in the sprayable mixture. Preferably, the sprayable composition is an aerosol. Suitable materials to be sprayed include, without limitation, cosmetic materials such as deodorants, perfumes, hair sprays, cleansers, and polishing agents as well as medicinal materials such as anti-asthma components, anti-halitosis components and any other medication or the like, including preferably any other medicament or agent intended to be inhaled. The medicament or other therapeutic agent is preferably present in the composition in a therapeutic amount, with a substantial portion of the balance of the composition comprising a composition of the present invention.

Aerosol products for industrial, consumer or medical use typically contain one or more propellants along with one or more active ingredients, inert ingredients or solvents. The propellant provides the force that expels the product in aerosolized form. While some aerosol products are propelled with compressed gases like carbon dioxide, nitrogen, nitrous oxide and even air, most commercial aerosols use liquefied gas propellants. The most commonly used liquefied gas propellants are hydrocarbons such as butane, isobutane, and propane. Dimethyl ether and HFC-152a (1,1-difluoroethane) are also used, either alone or in blends with the hydrocarbon propellants. Unfortunately, all of these liquefied gas propellants are highly flammable and their incorporation into aerosol formulations will often result in flammable aerosol products. The present invention provides liquefied gas propellants and aerosols for certain applications that are non-flammable or have reduced flammability.

### Blowing Agents, Foams and Foamable Compositions

Blowing agents may also comprise or constitute one or more of the compositions of the present invention. In certain preferred embodiments, the blowing agent comprises at least about 50% by weight of the present compositions, and in certain embodiments the blowing agent consists essentially of the present compositions. In certain preferred embodiments, the blowing agent compositions of the present invention include, in addition to compositions of the present invention, one or more of co-blowing agents, fillers, vapor pressure modifiers, flame suppressants, stabilizers and like adjuvants.

In other embodiments, the invention provides foamable compositions. The foamable compositions of the present invention generally include one or more components capable of forming foam having a generally cellular structure and a blowing agent in accordance with the present invention. In certain embodiments, the one or more components comprise a thermosetting composition capable of forming foam and/or foamable compositions. Examples of thermosetting compositions include polyurethane and polyisocyanurate foam compositions, and also phenolic foam compositions. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure. In certain other embodiments, the one or more components comprise thermoplastic materials, particularly thermoplastic polymers and/or resins. Examples of thermoplastic foam components include polyolefins, such as polystyrene (PS), polyethylene (PE), polypropylene (PP) and polyethyleneterepthalate (PET), and foams formed there from, preferably low-density foams. In certain embodiments, the thermoplastic foamable composition is an extrudable composition.

The invention also relates to foam, and preferably closed cell foam, prepared from a polymer foam formulation containing a blowing agent comprising the compositions of the invention. In yet other embodiments, the invention provides foamable compositions comprising thermoplastic or polyolefin foams, such as polystyrene (PS), polyethylene (PE), polypropylene (PP), styrene-acrylonitrile copolymers, and polyethyleneterpthalate (PET) foams, preferably low-density foams.

It will be appreciated by those skilled in the art, especially in view of the disclosure contained herein, that the order and manner in which the blowing agent of the present invention is formed and/or added to the foamable composition does not generally affect the operability of the present invention. For example, in the case of extrudable foams, it is possible that the various components of the blowing agent, and even the components of the present composition, be not be mixed in advance of introduction to the extrusion equipment, or even that the components are not added to the same location in the extrusion equipment. Thus, in certain embodiments it may be desired to introduce one or more components of the blowing agent at first location in the extruder, which is upstream of the place of addition of one or more other components of the blowing agent, with the expectation that the components will come together in the extruder and/or operate more effectively in this manner. Nevertheless, in certain embodiments, two or more components of the blowing agent are combined in advance and introduced together into the foamable composition, either directly or as part of premix which is then further added to other parts of the foamable composition.

In certain preferred embodiments, dispersing agents, cell stabilizers, surfactants and other additives may also be incorporated into the blowing agent compositions of the present invention. Surfactants are optionally but preferably added to serve as cell stabilizers. Some representative materials are sold under the names of DC-193, B-8404, and L-5340 which are, generally, polysiloxane polyoxyalkylene block copolymers such as those disclosed in U.S. Pat. Nos. 2,834,748, 2,917,480, and 2,846,458, each of which is incorporated herein by reference. Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloropropyl) phosphate, diammonium phosphate, various halogenated aromatic compounds, antimony oxide, aluminum trihydrate, polyvinyl chloride, and the like.

Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention.

One embodiment of the present invention relates to methods of forming polyurethane and polyisocyanurate foams. The methods generally comprise providing a blowing agent composition of the present inventions, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology, ” Volumes I and II, Saunders and Frisch, 1962, John Wiley and Sons, New York, N.Y., which is incorporated herein by reference, may be used or adapted for use in accordance with the foam embodiments of the present invention. In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives. It is convenient in many applications to provide the components for polyurethane or polyisocyanurate foams in pre-blended formulations.

Most typically, the foam formulation is pre-blended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, and even other polyols can be added as a third stream to the mix head or reaction site. Most preferably, however, they are all incorporated into one B-component as described above.

### Cleaning Methods

The present invention also provides methods of removing contaminants from a product, part, component, substrate, or any other article or portion thereof by applying to the article a composition of the present invention. For the purposes of convenience, the term “article” is used herein to refer to all such products, parts, components, substrates, and the like and is further intended to refer to any surface or portion thereof. Furthermore, the term “contaminant” is intended to refer to any unwanted material or substance present on the article, even if such substance is placed on the article intentionally. For example, in the manufacture of semiconductor devices it is common to deposit a photoresist material onto a substrate to form a mask for the etching operation and to subsequently remove the photoresist material from the substrate. The term “contaminant” as used herein is intended to cover and encompass such a photo resist material.

Preferred methods of the present invention comprise applying the present composition to the article. Although it is contemplated that numerous and varied cleaning techniques can employ the compositions of the present invention to good advantage, it is considered to be particularly advantageous to use the present compositions in connection with supercritical cleaning techniques. Supercritical cleaning is disclosed in U.S. Pat. No. 6,589,355, which is assigned to the assignee of the present invention and incorporated herein by reference. For supercritical cleaning applications, it is preferred in certain embodiments to include in the present cleaning compositions, in addition to the compositions of the present invention, one or more additional components, such as CO2 and other additional components known for use in connection with supercritical cleaning applications. It may also be possible and desirable in certain embodiments to use the present cleaning compositions in connection with particular vapor degreasing and solvent cleaning methods.

### Sterilization Methods

Many articles, devices and materials, particularly for use in the medical field, must be sterilized prior to use for the health and safety reasons, such as the health and safety of patients and hospital staff The present invention provides methods of sterilizing comprising contacting the articles, devices or material to be sterilized with a compound or composition of the present invention, in combination with one or more sterilizing agents. While many sterilizing agents are known in the art and are considered to be adaptable for use in connection with the present invention, in certain preferred embodiments sterilizing agent comprises ethylene oxide, formaldehyde, hydrogen peroxide, chlorine dioxide, ozone and combinations of these. In certain embodiments, ethylene oxide is the preferred sterilizing agent. Those skilled in the art, in view of the teachings contained herein, will be able to readily determine the relative proportions of sterilizing agent and the present compound(s) be used in connection with the present sterilizing compositions and methods, and all such ranges are within the broad scope hereof As is known to those skilled in the art, certain sterilizing agents, such as ethylene oxide, are relatively flammable components, and the compound(s) accordance with the present invention are included in the present compositions in amounts effective, together with other components present in the composition, to reduce the flammability of the sterilizing composition to acceptable levels.

The sterilization methods of the present invention may be either high or low-temperature sterilization of the present invention involves the use of a compound or composition of the present invention at a temperature of from about 250° F. to about 270° F., preferably in a substantially sealed chamber. The process can be completed usually in less than about 2 hours. However, some articles, such as plastic articles and electrical components, cannot withstand such high temperatures and require low-temperature sterilization. In low temperature sterilization methods, the article to be sterilized is exposed to a fluid comprising a composition of the present invention at a temperature of from about room temperature to about 200° F., more preferably at a temperature of from about room temperature to about 100° F.

The low-temperature sterilization of the present invention is preferably at least a two-step process performed in a substantially sealed, preferably air tight, chamber. In the first step (the sterilization step), the articles having been cleaned and wrapped in gas permeable bags are placed in the chamber. Air is then evacuated from the chamber by pulling a vacuum and perhaps by displacing the air with steam. In certain embodiments, it is preferable to inject steam into the chamber to achieve a relative humidity that ranges preferably from about 30% to about 70%.

Such humidities may maximize the sterilizing effectiveness of the sterilant, which is introduced into the chamber after the desired relative humidity is achieved.

After a period of time sufficient for the sterilant to permeate the wrapping and reach the interstices of the article, the sterilant and steam are evacuated from the chamber.

In the preferred second step of the process (the aeration step), the articles are aerated to remove sterilant residues. Removing such residues is particularly important in the case of toxic sterilants, although it is optional in those cases in which the substantially non-toxic compounds of the present invention are used. Typical aeration processes include air washes, continuous aeration, and a combination of the two. An air wash is a batch process and usually comprises evacuating the chamber for a relatively short period, for example, 12 minutes, and then introducing air at atmospheric pressure or higher into the chamber. This cycle is repeated any number of times until the desired removal of sterilant is achieved.

Continuous aeration typically involves introducing air through an inlet at one side of the chamber and then drawing it out through an outlet on the other side of the chamber by applying a slight vacuum to the outlet.

### EXAMPLES

### Example 1

To a high-pressure cylinder was added a composition containing 21 wt % R-32 (difluoromethane), 25 wt % R-125 (pentafluoroethane), 22 wt % R-1234yf (2,3,3,3-tetrafluoropropene), and 32 wt % R-134a (1,1,1,2-tetrafluoroethane). Afterwards, the liquid and vapor fractions of the cylinder contents were analyzed by gas chromatography to determine the composition. The compositions are shown in Table 6; each of the compositions are either non-flammable or have very low flammability characteristics.

TABLE 6
Example 1: Composition of refrigerant fractions

| | R-32 | R-125 | R-1234yf | R-134a |
|---|---|---|---|---|
| | (wt %) | (wt %) | (wt %) | (wt %) |
| Overall | 21 | 25 | 22 | 32 |
| Liquid | 19 | 24 | 24 | 33 |
| Vapor | 31 | 30 | 18 | 21 |

### EXAMPLES

### Refrigeration Equipment Testing

Equipment testing was performed in a environmentally controlled facility that consists of side-by-side insulated chambers designed for the testing of air-conditioning and refrigeration equipment. Each chamber uses independent control systems to regulate temperature, humidity, and airflow to characterize the performance of full-scale HVACR systems under a wide range of environmental conditions. The system was installed with a medium-to-low temperature Walk-in-Cooler type R-22 refrigeration system. This system is driven by a 1-½ HP, semi-hermetic, Copeland compressor, with a matched Bohn evaporator and Sporlan thermostatic expansion valve. Pressure transducers and resistance temperature detectors are installed throughout to determine the refrigerant state at key points in the system. A Coriolis meter is used to measure refrigerant flow rates, while wattmeters are used to measure power consumption of the system and its components. Finally, a video camera is used to remotely monitor the oil levels in the compressor sight glass.

System performance could be evaluated at various system conditions; values for capacity (CAP) and performance (COP) were calculated following the run using measurements of system conditions and the thermodynamic properties of the refrigerant. Oil return was evaluated by monitoring the oil level in the compressor sight glass; combinations of refrigerant/oil that produced a stable running oil level that remained within the OEM's guidelines were considering passing.

Oil logging in the system using an immiscible or partially miscible lubricant could also be inferred by comparing the performance and operating conditions (eg. temperatures, pressures, flowrates) of refrigerant when using the immiscible or partially miscible lubricant to the performance and operating conditions when using a miscible lubricant.

### Comparative Example 2

The refrigeration system was charged with R-22. The lubricant was a commercial 150 SUS viscosity mineral oil (MO) (National 150 Refrigeration Oil). The testing facility was operated at 100° F. ambient temperature (compressor-side) and box temperatures (evaporator-side) of 50° F., 25° F., and 0° F. There was satisfactory oil return at all conditions. Values of the CAP and COP were calculated following the tests using the measured system conditions and thermodynamic data for the refrigerant. Results are given in Table 7; the capacity, CAP, is expressed relative to the value for R-22 at the same operating conditions.

### Comparative Example 3

The refrigeration system was operated as in Comparative Example 2 except the refrigerant was R-407C and the lubricant was a commercial POE oil (Copeland Ultra 22CC). There was satisfactory oil return at all conditions. For each box temperature, the capacity, relative to R-22, and the COP are given in Table 7.

### Comparative Example 4

The refrigeration system was operated as in Comparative Example 3 except the refrigerant was R-422D. There was satisfactory oil return at all conditions. For each box temperature, the capacity, relative to R-22, and the COP are given in Table 7.

### Comparative Example 5

The refrigeration system was operated as in Comparative Example 3 except the refrigerant was R-427A. There was satisfactory oil return at all conditions. For each box temperature, the capacity, relative to R-22, and the COP are given in Table 7.

### Comparative Example 6

The refrigeration system was operated as in Comparative Example 3 except the refrigerant was R-438A. There was satisfactory oil return at all conditions. For each box temperature, the capacity, relative to R-22, and the COP are given in Table 7.

### Example 7

The refrigeration system was operated as in Comparative Example 3 except the refrigerant was a blend of about 21% R-32, 25% R-125, 22% R-1234yf, and 32% R-134a by weight (Ex. 7). There was satisfactory oil return at all conditions. For each box temperature, the capacity, relative to R-22, and the COP are given in Table 7.

FIG. 1 shows a comparison of the CAP for R-422D, R-427A, R-438A, and Ex. 7 relative to the CAP of R-407C. The capacity of Ex. 7 was greater than that of the other R-22 replacements at all conditions tested, particularly at the lower box temperatures.

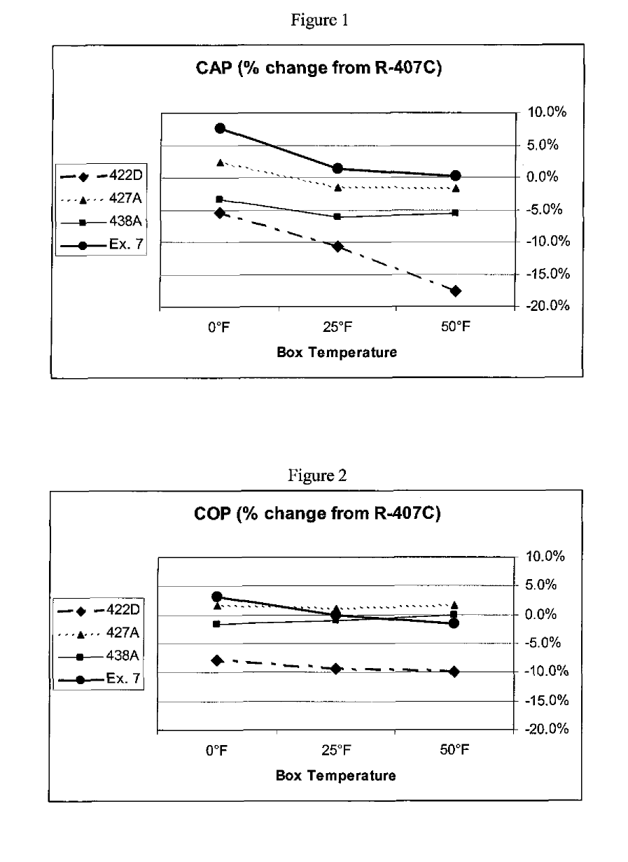

FIG. 2 shows a comparison of the COP for R-422D, R-427A, R-438A, and Ex. 7 relative to the COP of R-407C. The COP of Ex. 7 was significantly higher than that of R-422D and close to that of R-407C, R-438A, and R-427A at 25° F. and 50° F. box temperatures. At 0° F. box temperature, Ex. 7 had a greater COP than R-407C, R-427A, R-43 8A, or R-422D.

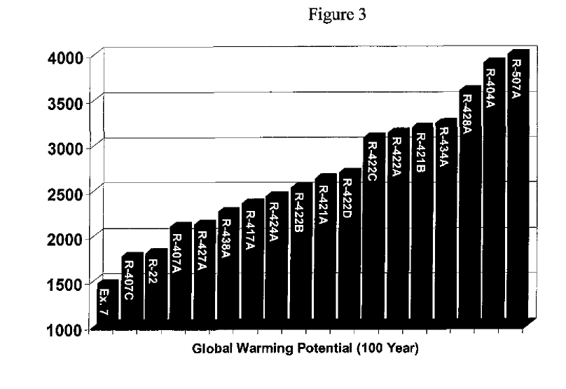

FIG. 3 shows the calculated GWP for R-22, Ex. 7, and numerous R-22 retrofits including those of Comparative Examples 3, 4, 5, and 6. The GWP of Ex. 7 is between 17% and 18% lower than that of R-407C or R-22 and about 45% lower than that of R-422D.

TABLE 7
CAP and COP for Refrigerants tested at 100°
F. Ambient Temperature and Box Temperatures of
50° F., 25° F., and 0° F.

| | | | Box T | CAP | |
|---|---|---|---|---|---|
| Ex. | Refrigerant | Oil | (° F.) | (%-CAP_{R-22}) | COP |
| Comp. Ex. 2 | R-22 | MO | 50 | 100% | 1.27 |
| | | | 25 | 100% | 1.07 |
| | | | 0 | 100% | 0.77 |
| Comp. Ex. 3 | R-407C | POE | 50 | 93.0% | 1.21 |
| | | | 25 | 88.3% | 0.97 |
| | | | 0 | 78.5% | 0.64 |
| Comp. Ex. 4 | R-422D | POE | 50 | 76.5% | 1.09 |
| | | | 25 | 78.9% | 0.88 |
| | | | 0 | 74.2% | 0.59 |
| Comp. Ex. 5 | R-427A | POE | 50 | 91.5% | 1.23 |
| | | | 25 | 87.0% | 0.98 |
| | | | 0 | 80.3% | 0.65 |
| Comp. Ex. 6 | R-438A | POE | 50 | 87.8% | 1.21 |
| | | | 25 | 83.0% | 0.96 |
| | | | 0 | 75.8% | 0.63 |
| Ex. 7 | 32/125/1234yf/134a | POE | 50 | 93.2% | 1.19 |
| | (21/25/22/32) | | 25 | 89.6% | 0.97 |
| | | | 0 | 84.5% | 0.66 |

### Example 8

### R-22 Retrofits with Mineral Oil

Using mineral oil as the lubricant (National 150 Refrigeration Oil), the refrigeration equipment was charged with the refrigerant of Example 7, containing about 21% R-32, 25% R-125, 22% R-1234yf, and 32% R-134a. The system was operated at an ambient (condenser-side) temperature of 100° F. and a box (evaporator-side) temperature of 50° F. There was satisfactory oil return during stable operation.

The same evaluation was performed with R-422D, R-438A, and R-427A. In these cases the oil return was poor, where the oil level in the compressor dropped below OEM guidelines.

### Example 9

### Alkyl Benzene Oil

Using a commercial grade alkyl benzene refrigeration oil, the refrigeration system was charged with the refrigerant of Example 7, containing about 21% R-32, 25% R-125, 22% R-1234yf, and 32% R-134a. The system was operated at an ambient (condenser-side) temperature of 100° F. and a box (evaporator-side) temperature of 50° F. There was satisfactory oil return during stable operation.

### Example 10

### Performance Data

The performance data for heat transfer compositions of the present invention under refrigeration and air conditioning conditions are given in Tables 8, 9, and 10. In Table 8 the results compared to R-22, R-404A, and R-407C. In Table 9 the results compared to R-134a. In Table 10 the results compared to R-410A. The values of the constituents (R-1234yf, R-32, R-134a, R-125) for each composition are given as a percentage by weight.

The results are based upon the following conditions:

| | |
|---|---|
| Evaporator inlet temperature: | −30° C. |
| Condensation temperature: | 40° C. |
| Superheat: | 15° C. |

Compressor isentropic efficiency is a calculated function of the compression ratio at the operating conditions and was determined according to data in: S. K. Wang, “Handbook of air conditioning and refrigeration”, 2^{nd} ed. McGraw Hill (2000); and 2004 ASHRAE Handbook: HVAC Systems and Equipment. The system has an internal heat exchanger and evaporator and condenser are in counter current mode.

Tevap-out is the evaporator outlet temperature. Tcomp-out is the compressor outlet temperature. Pevap is the evaporator pressure. Pcond is the condenser pressure. CAP is the capacity and is represented relative to that of R-22 in Table 8, R-134a in

Table 9, and R-410A in Table 10. %-COP/COP-L is the coefficient of performance relative to the Lorenz coefficient of performance.

TABLE 8
Comparison to R-22, R-404A, R-407C

| R-22 | | | | −30 | 172 | 40 | 33 | 1.6 | 15.3 | 9.3 | 0 | 49.2 | 100 | 35 |
|---|---|---|---|---|---|---|---|---|---|---|---|---|---|---|
| R-404A | | | | −30 | 100 | 40 | 33 | 2.1 | 18.1 | 8.8 | 0.5 | 53.8 | 97 | 33 |
| R-407C | | | | −25 | 130 | 35 | 28 | 1.7 | 15.3 | 9.0 | 4.6 | 52.3 | 105 | 37 |
| | | | | | | | Expansion- | | | compres- | | | | |
| | | | | Tevap- | Tcomp- | Tcond- | valve | | | sion | | | | COP/ |
| R-1234yf | R-32 | R-134a | R-125 | out | out | out | inlet T | Pevap | Pcond | ratio | | compressor | CAP | COP-L |
| % | % | % | % | (° C.) | (° C.) | (° C.) | (° C.) | (bar) | (bar) | (p/p) | glide | efficiency | % | % |
| 75 | 15 | 5 | 5 | −26 | 98 | 33 | 25 | 1.6 | 13.2 | 8.5 | 4.0 | 55.9 | 89 | 38 |
| 70 | 15 | 5 | 10 | −26 | 99 | 33 | 25 | 1.6 | 13.6 | 8.5 | 4.0 | 56.0 | 91 | 38 |
| 65 | 15 | 5 | 15 | −26 | 99 | 33 | 26 | 1.6 | 14.0 | 8.5 | 3.9 | 56.1 | 93 | 38 |
| 60 | 15 | 5 | 20 | −26 | 100 | 34 | 27 | 1.7 | 14.3 | 8.5 | 3.8 | 55.9 | 94 | 38 |
| 55 | 15 | 5 | 25 | −26 | 100 | 34 | 27 | 1.7 | 14.8 | 8.5 | 3.7 | 55.9 | 96 | 37 |
| 50 | 15 | 5 | 30 | −26 | 101 | 34 | 28 | 1.8 | 15.2 | 8.5 | 3.6 | 55.8 | 98 | 37 |
| 45 | 15 | 5 | 35 | −27 | 102 | 35 | 28 | 1.8 | 15.7 | 8.6 | 3.5 | 55.7 | 100 | 37 |
| 40 | 15 | 5 | 40 | −27 | 102 | 35 | 28 | 1.9 | 16.2 | 8.6 | 3.3 | 55.6 | 102 | 37 |
| 65 | 15 | 15 | 5 | −26 | 103 | 34 | 25 | 1.5 | 13.3 | 8.7 | 3.6 | 54.7 | 89 | 38 |
| 60 | 15 | 15 | 10 | −26 | 103 | 34 | 26 | 1.6 | 13.6 | 8.7 | 3.5 | 54.6 | 90 | 38 |
| 55 | 15 | 15 | 15 | −26 | 104 | 34 | 26 | 1.6 | 14.0 | 8.7 | 3.5 | 54.6 | 92 | 37 |
| 50 | 15 | 15 | 20 | −27 | 105 | 34 | 27 | 1.7 | 14.4 | 8.7 | 3.5 | 54.5 | 94 | 37 |
| 45 | 15 | 15 | 25 | −27 | 105 | 34 | 27 | 1.7 | 14.8 | 8.7 | 3.4 | 54.4 | 96 | 37 |
| 40 | 15 | 15 | 30 | −27 | 106 | 35 | 28 | 1.7 | 15.2 | 8.7 | 3.4 | 54.4 | 97 | 37 |
| 55 | 15 | 25 | 5 | −27 | 107 | 34 | 26 | 1.5 | 13.3 | 8.8 | 3.3 | 53.4 | 88 | 37 |
| 50 | 15 | 25 | 10 | −27 | 108 | 34 | 26 | 1.5 | 13.6 | 8.8 | 3.3 | 53.3 | 90 | 37 |
| 45 | 15 | 25 | 15 | −27 | 109 | 34 | 27 | 1.6 | 14.0 | 8.9 | 3.4 | 53.2 | 91 | 37 |
| 65 | 25 | 5 | 5 | −25 | 104 | 33 | 26 | 1.9 | 15.2 | 8.2 | 4.7 | 58.7 | 107 | 40 |
| 60 | 25 | 5 | 10 | −25 | 106 | 33 | 27 | 1.9 | 15.6 | 8.2 | 4.5 | 58.3 | 108 | 40 |
| 55 | 25 | 5 | 15 | −26 | 107 | 34 | 27 | 1.9 | 16.0 | 8.3 | 4.3 | 57.9 | 109 | 39 |
| 50 | 25 | 5 | 20 | −26 | 108 | 34 | 28 | 2.0 | 16.5 | 8.3 | 4.1 | 57.5 | 111 | 39 |
| 45 | 25 | 5 | 25 | −26 | 110 | 35 | 28 | 2.0 | 16.9 | 8.4 | 3.9 | 57.2 | 112 | 38 |
| 40 | 25 | 5 | 30 | −26 | 111 | 35 | 29 | 2.1 | 17.4 | 8.4 | 3.6 | 56.8 | 114 | 38 |
| 35 | 25 | 5 | 35 | −27 | 112 | 36 | 29 | 2.1 | 17.9 | 8.5 | 3.4 | 56.4 | 115 | 37 |
| 30 | 25 | 5 | 40 | −27 | 113 | 36 | 30 | 2.2 | 18.4 | 8.5 | 3.1 | 56.0 | 117 | 37 |
| 55 | 25 | 15 | 5 | −26 | 109 | 34 | 26 | 1.8 | 15.2 | 8.3 | 4.3 | 57.4 | 106 | 40 |
| 50 | 25 | 15 | 10 | −26 | 110 | 34 | 27 | 1.9 | 15.6 | 8.4 | 4.2 | 56.9 | 107 | 39 |
| 45 | 25 | 15 | 15 | −26 | 112 | 34 | 27 | 1.9 | 16.0 | 8.4 | 4.0 | 56.6 | 109 | 39 |
| 40 | 25 | 15 | 20 | −26 | 113 | 35 | 28 | 1.9 | 16.4 | 8.5 | 3.9 | 56.2 | 110 | 38 |
| 35 | 25 | 15 | 25 | −26 | 114 | 35 | 28 | 2.0 | 16.8 | 8.5 | 3.7 | 55.9 | 111 | 38 |
| 30 | 25 | 15 | 30 | −26 | 116 | 35 | 29 | 2.0 | 17.3 | 8.6 | 3.5 | 55.6 | 113 | 37 |
| 25 | 25 | 15 | 35 | −27 | 117 | 36 | 30 | 2.1 | 17.7 | 8.6 | 3.4 | 55.3 | 115 | 37 |
| 45 | 25 | 25 | 5 | −26 | 114 | 34 | 27 | 1.8 | 15.1 | 8.5 | 4.2 | 56.1 | 105 | 39 |
| 40 | 25 | 25 | 10 | −26 | 115 | 34 | 27 | 1.8 | 15.4 | 8.5 | 4.1 | 55.7 | 106 | 39 |
| 35 | 25 | 25 | 15 | −26 | 116 | 34 | 28 | 1.8 | 15.8 | 8.6 | 4.0 | 55.4 | 107 | 38 |
| 30 | 25 | 25 | 20 | −26 | 118 | 35 | 28 | 1.9 | 16.2 | 8.6 | 3.9 | 55.2 | 109 | 38 |
| 25 | 25 | 25 | 25 | −26 | 119 | 35 | 28 | 1.9 | 16.6 | 8.6 | 3.8 | 54.9 | 111 | 37 |
| 20 | 25 | 25 | 30 | −26 | 120 | 35 | 29 | 2.0 | 17.0 | 8.7 | 3.7 | 54.7 | 112 | 37 |
| 15 | 25 | 25 | 35 | −26 | 121 | 36 | 29 | 2.0 | 17.4 | 8.7 | 3.6 | 54.5 | 114 | 37 |
| 35 | 25 | 35 | 5 | −26 | 119 | 34 | 27 | 1.7 | 14.9 | 8.6 | 4.2 | 54.9 | 103 | 38 |
| 30 | 25 | 35 | 10 | −26 | 120 | 34 | 28 | 1.8 | 15.2 | 8.7 | 4.1 | 54.7 | 105 | 38 |
| 25 | 25 | 35 | 15 | −26 | 121 | 35 | 28 | 1.8 | 15.6 | 8.7 | 4.1 | 54.4 | 106 | 38 |
| 20 | 25 | 35 | 20 | −26 | 122 | 35 | 28 | 1.8 | 15.9 | 8.7 | 4.1 | 54.3 | 108 | 38 |
| 15 | 25 | 35 | 25 | −26 | 123 | 35 | 28 | 1.9 | 16.2 | 8.7 | 4.1 | 54.1 | 110 | 37 |
| 10 | 25 | 35 | 30 | −26 | 124 | 35 | 29 | 1.9 | 16.6 | 8.8 | 4.1 | 54.0 | 111 | 37 |
| 5 | 25 | 35 | 35 | −26 | 125 | 35 | 29 | 1.9 | 17.0 | 8.8 | 4.1 | 54.0 | 113 | 37 |
| 25 | 25 | 45 | 5 | −26 | 124 | 34 | 28 | 1.7 | 14.6 | 8.8 | 4.3 | 53.7 | 101 | 38 |
| 20 | 25 | 45 | 10 | −26 | 125 | 34 | 28 | 1.7 | 14.9 | 8.8 | 4.3 | 53.6 | 103 | 38 |
| 15 | 25 | 45 | 15 | −26 | 126 | 35 | 28 | 1.7 | 15.3 | 8.8 | 4.3 | 53.5 | 105 | 37 |
| 10 | 25 | 45 | 20 | −26 | 127 | 35 | 28 | 1.8 | 15.6 | 8.8 | 4.4 | 53.4 | 107 | 37 |
| 5 | 25 | 45 | 25 | −26 | 128 | 35 | 28 | 1.8 | 15.9 | 8.8 | 4.4 | 53.3 | 108 | 37 |
| 10 | 25 | 60 | 5 | −26 | 133 | 34 | 28 | 1.6 | 14.2 | 9.0 | 4.5 | 51.7 | 99 | 37 |
| 50 | 40 | 5 | 5 | −26 | 122 | 35 | 29 | 2.2 | 18.1 | 8.2 | 4.0 | 58.3 | 125 | 40 |
| 45 | 40 | 5 | 10 | −26 | 124 | 36 | 30 | 2.2 | 18.5 | 8.3 | 3.7 | 57.7 | 126 | 39 |
| 40 | 40 | 5 | 15 | −27 | 126 | 36 | 31 | 2.3 | 19.0 | 8.4 | 3.4 | 57.1 | 126 | 38 |
| 35 | 40 | 5 | 20 | −27 | 127 | 36 | 31 | 2.3 | 19.4 | 8.4 | 3.1 | 56.6 | 128 | 38 |
| 30 | 40 | 5 | 25 | −27 | 129 | 37 | 31 | 2.3 | 19.9 | 8.5 | 2.8 | 56.1 | 129 | 37 |
| 40 | 40 | 15 | 5 | −26 | 126 | 35 | 30 | 2.1 | 17.8 | 8.4 | 3.9 | 57.3 | 123 | 39 |
| 35 | 40 | 15 | 10 | −26 | 128 | 36 | 30 | 2.2 | 18.2 | 8.4 | 3.7 | 56.8 | 124 | 38 |
| 30 | 40 | 15 | 15 | −27 | 131 | 36 | 33 | 2.2 | 18.6 | 8.5 | 3.4 | 56.0 | 120 | 36 |
| 25 | 40 | 15 | 20 | −27 | 132 | 36 | 31 | 2.2 | 19.1 | 8.5 | 3.3 | 55.8 | 127 | 37 |
| 20 | 40 | 15 | 25 | −27 | 133 | 37 | 31 | 2.3 | 19.5 | 8.6 | 3.1 | 55.4 | 128 | 37 |
| 15 | 40 | 15 | 30 | −27 | 135 | 37 | 31 | 2.3 | 19.9 | 8.6 | 2.9 | 55.0 | 130 | 37 |
| 30 | 40 | 25 | 5 | −26 | 131 | 35 | 30 | 2.1 | 17.5 | 8.5 | 4.0 | 56.5 | 122 | 39 |
| 25 | 40 | 25 | 10 | −26 | 132 | 35 | 30 | 2.1 | 17.8 | 8.5 | 3.9 | 56.0 | 123 | 38 |
| 20 | 40 | 25 | 15 | −26 | 134 | 36 | 30 | 2.1 | 18.2 | 8.6 | 3.8 | 55.6 | 124 | 38 |
| 15 | 40 | 25 | 20 | −26 | 136 | 36 | 31 | 2.2 | 18.6 | 8.6 | 3.6 | 55.2 | 125 | 37 |
| 10 | 40 | 25 | 25 | −26 | 138 | 36 | 30 | 2.2 | 18.9 | 8.6 | 3.6 | 55.0 | 127 | 37 |
| 5 | 40 | 25 | 30 | −27 | 139 | 36 | 30 | 2.2 | 19.3 | 8.7 | 3.5 | 54.7 | 129 | 37 |
| 20 | 40 | 35 | 5 | −26 | 135 | 35 | 30 | 2.0 | 17.1 | 8.5 | 4.3 | 55.8 | 120 | 39 |
| 15 | 40 | 35 | 10 | −26 | 137 | 35 | 30 | 2.0 | 17.4 | 8.6 | 4.3 | 55.4 | 122 | 38 |
| 10 | 40 | 35 | 15 | −26 | 139 | 35 | 30 | 2.1 | 17.7 | 8.6 | 4.2 | 55.1 | 123 | 38 |
| 5 | 40 | 35 | 20 | −26 | 140 | 36 | 30 | 2.1 | 18.0 | 8.7 | 4.2 | 54.8 | 125 | 38 |
| 10 | 40 | 45 | 5 | −25 | 140 | 35 | 30 | 1.9 | 16.6 | 8.6 | 4.6 | 55.0 | 119 | 38 |
| 5 | 40 | 45 | 10 | −25 | 142 | 35 | 29 | 1.9 | 16.9 | 8.7 | 4.6 | 54.7 | 120 | 38 |

TABLE 9
Comparison to R-134a

| R-134a | | | | −30 | 98 | 40 | 32 | 0.8 | 10.1 | 12.0 | 0.0 | 63.7 | 100 | 44 |
|---|---|---|---|---|---|---|---|---|---|---|---|---|---|---|
| | | | | | | | Expansion- | | | compres- | | | | |
| | | | | Tevap- | Tcomp- | Tcond- | valve | | | sion | | | | COP/ |
| R1234yf | R-32 | R134a | R-125 | out | out | out | inlet T | Pevap | Pcond | ratio | | compressor | CAP | COP-L |
| % | % | % | % | (° C.) | (° C.) | (° C.) | (° C.) | (bar) | (bar) | (P/P) | glide | efficiency | % | % |
| 85 | 5 | 5 | 5 | −28 | 79 | 36 | 28 | 1.2 | 11.3 | 9.4 | 1.8 | 67.6 | 126 | 45 |
| 80 | 5 | 5 | 10 | −28 | 79 | 36 | 28 | 1.2 | 11.6 | 9.3 | 2.0 | 67.8 | 130 | 45 |
| 75 | 5 | 5 | 15 | −28 | 79 | 35 | 28 | 1.3 | 11.9 | 9.2 | 2.1 | 67.9 | 134 | 45 |
| 70 | 5 | 5 | 20 | −28 | 79 | 35 | 28 | 1.3 | 12.2 | 9.2 | 2.3 | 68.1 | 138 | 45 |
| 65 | 5 | 5 | 25 | −28 | 79 | 35 | 28 | 1.4 | 12.6 | 9.1 | 2.4 | 68.2 | 142 | 45 |
| 60 | 5 | 5 | 30 | −28 | 79 | 35 | 28 | 1.4 | 13.0 | 9.0 | 2.5 | 68.3 | 146 | 45 |
| 55 | 5 | 5 | 35 | −27 | 79 | 35 | 28 | 1.5 | 13.4 | 9.0 | 2.5 | 68.4 | 151 | 45 |
| 50 | 5 | 5 | 40 | −27 | 79 | 35 | 29 | 1.5 | 13.8 | 8.9 | 2.6 | 68.5 | 155 | 45 |
| 75 | 5 | 15 | 5 | −28 | 80 | 36 | 28 | 1.2 | 11.4 | 9.5 | 1.6 | 67.5 | 127 | 45 |
| 70 | 5 | 15 | 10 | −28 | 80 | 36 | 28 | 1.2 | 11.7 | 9.4 | 1.8 | 67.6 | 131 | 46 |
| 65 | 5 | 15 | 15 | −28 | 80 | 36 | 28 | 1.3 | 12.0 | 9.4 | 1.9 | 67.7 | 134 | 45 |
| 60 | 5 | 15 | 20 | −28 | 81 | 36 | 28 | 1.3 | 12.4 | 9.3 | 2.0 | 67.8 | 138 | 45 |
| 55 | 5 | 15 | 25 | −28 | 81 | 36 | 29 | 1.4 | 12.7 | 9.3 | 2.1 | 67.9 | 142 | 45 |
| 50 | 5 | 15 | 30 | −28 | 81 | 36 | 29 | 1.4 | 13.1 | 9.2 | 2.2 | 68.0 | 145 | 45 |
| 65 | 5 | 25 | 5 | −29 | 82 | 36 | 29 | 1.2 | 11.5 | 9.6 | 1.5 | 67.4 | 127 | 46 |
| 60 | 5 | 25 | 10 | −28 | 82 | 36 | 28 | 1.2 | 11.8 | 9.6 | 1.6 | 67.4 | 131 | 46 |
| 55 | 5 | 25 | 15 | −28 | 82 | 36 | 28 | 1.3 | 12.1 | 9.5 | 1.8 | 67.5 | 135 | 46 |
| 50 | 5 | 25 | 20 | −28 | 82 | 36 | 28 | 1.3 | 12.4 | 9.4 | 1.9 | 67.6 | 139 | 46 |
| 45 | 5 | 25 | 25 | −28 | 82 | 36 | 28 | 1.4 | 12.8 | 9.4 | 2.1 | 67.7 | 143 | 45 |
| 40 | 5 | 25 | 30 | −28 | 83 | 36 | 29 | 1.4 | 13.2 | 9.3 | 2.2 | 67.8 | 147 | 45 |
| 35 | 5 | 25 | 35 | −28 | 83 | 36 | 30 | 1.5 | 13.5 | 9.3 | 2.3 | 67.9 | 150 | 45 |
| 30 | 5 | 25 | 40 | −28 | 83 | 36 | 30 | 1.5 | 13.9 | 9.2 | 2.4 | 67.9 | 155 | 45 |
| 55 | 5 | 35 | 5 | −29 | 84 | 37 | 29 | 1.2 | 11.5 | 9.8 | 1.4 | 67.1 | 127 | 46 |
| 50 | 5 | 35 | 10 | −28 | 84 | 37 | 29 | 1.2 | 11.8 | 9.7 | 1.6 | 67.2 | 131 | 46 |
| 45 | 5 | 35 | 15 | −28 | 84 | 36 | 28 | 1.3 | 12.1 | 9.6 | 1.8 | 67.3 | 135 | 46 |
| 40 | 5 | 35 | 20 | −28 | 84 | 36 | 28 | 1.3 | 12.5 | 9.6 | 2.0 | 67.4 | 139 | 46 |
| 35 | 5 | 35 | 25 | −28 | 84 | 36 | 28 | 1.3 | 12.8 | 9.5 | 2.2 | 67.5 | 143 | 46 |
| 30 | 5 | 35 | 30 | −28 | 85 | 36 | 29 | 1.4 | 13.1 | 9.5 | 2.3 | 67.6 | 147 | 45 |
| 25 | 5 | 35 | 35 | −28 | 85 | 36 | 29 | 1.4 | 13.5 | 9.4 | 2.5 | 67.7 | 151 | 45 |
| 20 | 5 | 35 | 40 | −27 | 85 | 36 | 29 | 1.5 | 13.9 | 9.3 | 2.7 | 67.8 | 155 | 45 |
| 45 | 5 | 45 | 5 | −29 | 86 | 37 | 30 | 1.2 | 11.5 | 9.9 | 1.5 | 66.9 | 127 | 46 |
| 40 | 5 | 45 | 10 | −28 | 86 | 37 | 29 | 1.2 | 11.8 | 9.9 | 1.7 | 67.0 | 131 | 46 |
| 35 | 5 | 45 | 15 | −28 | 86 | 37 | 29 | 1.2 | 12.1 | 9.8 | 1.9 | 67.1 | 135 | 46 |
| 30 | 5 | 45 | 20 | −28 | 86 | 36 | 29 | 1.3 | 12.4 | 9.7 | 2.1 | 67.2 | 139 | 46 |
| 25 | 5 | 45 | 25 | −28 | 87 | 36 | 29 | 1.3 | 12.7 | 9.7 | 2.3 | 67.3 | 143 | 46 |
| 20 | 5 | 45 | 30 | −27 | 87 | 36 | 29 | 1.4 | 13.0 | 9.6 | 2.6 | 67.4 | 147 | 46 |
| 15 | 5 | 45 | 35 | −27 | 87 | 36 | 29 | 1.4 | 13.4 | 9.5 | 2.8 | 67.5 | 151 | 45 |
| 10 | 5 | 45 | 40 | −27 | 87 | 36 | 29 | 1.4 | 13.7 | 9.5 | 3.0 | 67.6 | 155 | 45 |
| 30 | 5 | 60 | 5 | −28 | 90 | 37 | 30 | 1.1 | 11.5 | 10.2 | 1.6 | 66.5 | 126 | 46 |
| 25 | 5 | 60 | 10 | −28 | 90 | 37 | 29 | 1.2 | 11.7 | 10.1 | 1.9 | 66.6 | 130 | 46 |
| 20 | 5 | 60 | 15 | −28 | 90 | 37 | 29 | 1.2 | 12.0 | 10.1 | 2.1 | 66.7 | 134 | 46 |
| 15 | 5 | 60 | 20 | −28 | 90 | 36 | 29 | 1.2 | 12.2 | 10.0 | 2.4 | 66.8 | 137 | 46 |
| 10 | 5 | 60 | 25 | −27 | 90 | 36 | 29 | 1.3 | 12.5 | 9.9 | 2.7 | 66.9 | 141 | 46 |
| 5 | 5 | 60 | 30 | −27 | 90 | 36 | 29 | 1.3 | 12.8 | 9.8 | 2.9 | 67.0 | 145 | 46 |

TABLE 10
Comparison to R-410A

| R-410A | | | | −30 | 153 | 40 | 35 | 2.7 | 24.2 | 8.9 | 0.06 | 52.5 | 100 | 33 |
|---|---|---|---|---|---|---|---|---|---|---|---|---|---|---|
| | | | | | | | Expansion- | | | compres- | | | | |
| | | | | Tevap- | Tcomp- | Tcond- | valve | | | sion | | | | COP/ |
| R-1234yf | R-32 | R-134a | R-125 | out | out | out | inlet T | Pevap | Pcond | ratio | | compressor | CAP | COP-L |
| % | % | % | % | (° C.) | (° C.) | (° C.) | (° C.) | (bar) | (bar) | (P/P) | glide | efficiency | % | % |
| 20 | 70 | 5 | 5 | −29 | 167 | 39 | 33 | 2.6 | 22.4 | 8.7 | 1.3 | 54.4 | 103 | 36 |
| 15 | 70 | 5 | 10 | −29 | 170 | 39 | 33 | 2.6 | 22.8 | 8.8 | 1.1 | 53.9 | 103 | 36 |
| 10 | 70 | 5 | 15 | −29 | 172 | 39 | 33 | 2.6 | 23.1 | 8.8 | 1.0 | 53.4 | 104 | 35 |
| 5 | 70 | 5 | 20 | −29 | 175 | 39 | 34 | 2.6 | 23.5 | 8.9 | 0.9 | 53.1 | 105 | 35 |
| 15 | 70 | 10 | 5 | −28 | 169 | 38 | 33 | 2.5 | 22.0 | 8.7 | 1.7 | 54.4 | 102 | 36 |
| 10 | 70 | 10 | 10 | −28 | 171 | 38 | 33 | 2.5 | 22.4 | 8.8 | 1.6 | 54.0 | 103 | 36 |
| 10 | 70 | 15 | 5 | −28 | 171 | 38 | 32 | 2.5 | 21.6 | 8.7 | 2.2 | 54.4 | 102 | 37 |
| 5 | 70 | 15 | 10 | −28 | 173 | 38 | 32 | 2.5 | 21.9 | 8.8 | 2.1 | 54.1 | 103 | 36 |
| 5 | 70 | 20 | 5 | −27 | 172 | 38 | 32 | 2.4 | 21.2 | 8.7 | 2.6 | 54.4 | 102 | 37 |
| 5 | 85 | 5 | 5 | −29 | 193 | 39 | 34 | 2.7 | 23.7 | 8.9 | 0.7 | 52.8 | 109 | 35 |

### Example 11

Examples of quazi-azeotrope compositions of the present invention are shown in Table 11.

TABLE 11
Quasi-Azeotrope Compositions

| | | | | | Pressure, | Pressure, | |
|---|---|---|---|---|---|---|---|
| | | | | | Sat. | Sat. | |
| R-1234yf | R-32 | R-134a | R-125 | Temperature | Liquid | Vapor | %-difference |
| % | % | % | % | (° C.) | (bar) | (bar) | (%) |
| 20 | 70 | 5 | 5 | −30 | 2.6 | 2.4 | 6 |
| 15 | 70 | 5 | 10 | −30 | 2.6 | 2.5 | 6 |
| 10 | 70 | 5 | 15 | −30 | 2.6 | 2.5 | 5 |
| 5 | 70 | 5 | 20 | −30 | 2.7 | 2.5 | 4 |
| 15 | 70 | 10 | 5 | −30 | 2.6 | 2.4 | 9 |
| 10 | 70 | 10 | 10 | −30 | 2.6 | 2.4 | 8 |
| 5 | 85 | 5 | 5 | −30 | 2.7 | 2.6 | 4 |

### EXAMPLES

### Refrigerant Flammability

Flammability testing was performed in accordance with ASTM E 681-01. Attention was paid to the modifications described in ASHRAE Addendum 34p-92. An overview follows:

Set up the apparatus as shown in ASTM E 681 using a 12 L flask. Confirm the relative humidity of the air supply to be 50%. An electronic spark ignition source is used. Record the barometric pressure at the test location. Heat the apparatus to the desired test temperature, which for these tests was 60° C. Evacuate the system. Calculate the amount of each component necessary for the test volume. Add the indicated quantities to the system. Bring to ambient barometric pressure with air (controlled humidity). Close off the test chamber and mix for at least five minutes. Make sure the temperature of the test sample is at 60° C. Turn off the lights and stirrer. Loosen the cover. Ignite. A test sample is defined as flammable when there is an upward and outward extension from the point of ignition to within 2 inch of the flask wall which is continuous for greater than a 90-degree angle as measured from the point of ignition.

A refrigerant composition is tested using this procedure across a range of concentrations in air. The lower flammable limit (LFL) describes the lowest concentration (leanest) of the refrigerant in air that sustains a flame and is found to be flammable using the procedure described above. The upper flammable limit (UFL) describes the highest concentration (richest) of the refrigerant in air that sustains a flame and is found to be flammable using the procedure described above. A refrigerant composition is deemed non-flammable when there are no concentrations in air that can sustain a flame, and therefore there are no flame limits.

### Example 12

Flammability tests were performed on binary mixtures of R-1234yf/R-134a, R-125/R-1234yf, R-32/R-125, R-32/R-134a. The results are shown in Table 12. The critical flammable ratio of R-1234yf/R-134a was found to be from 55 to 60 wt % R-1234yf The critical flammability ratio of R-125/R-1234yf was found to be from 70 to 75 wt % R-1234yf. The critical flammable ratio of R-32/R-134a was found to be from 35 to 40 wt % R-32. The critical flammable ratio of R-32/R-125 was found to be from 55 to 60 wt % R-32.

TABLE 12
Flammability of binary mixtures of refrigerants at 60° C.

| | | Flammable (F)/ |
|---|---|---|
| | | Non-Flammable (NF) |
| R-1234yf | R-134a | |
| 60 wt % | 40 wt % | F |
| 55 wt % | 45 wt % | NF |
| R-125 | R-1234yf | |
| 25 wt % | 75 wt % | F |
| 30 wt % | 70 wt % | NF |
| R-32 | R-134a | |
| 40 wt % | 60 wt % | F |
| 35 wt % | 65 wt % | NF |
| R-32 | R-125 | |
| 60 wt % | 40 wt % | F |
| 55 wt % | 45 wt % | NF |

### Example 13

Flammability tests were performed on a quaternary refrigerant mixture with a vapor composition of approximately 32 wt % R-32, 34 wt % R-125, 14 wt % R-1234yf, and 20 wt % R-134a. The refrigerant mixture was found to be non-flammable at 60° C. The liquid phase of the refrigerant mixture had a composition of approximately 19.5 wt % R-32, 26.5 wt % R-125, 23 wt % R-1234yf, and 31 wt % R-134a.

### Example 14

### Impact of Leakage of Vapor

A vessel is charged with an initial composition of refrigerant. The vessel and contents are maintained at 25° C. The initial vapor phase composition and pressure in the vessel are measured. The composition is allowed to leak from the vapor phase at a constant rate while maintaining the temperature at 25° C. After 50 percent by weight of the composition has leaked from the vessel, the vapor phase composition and pressure in the vessel are measured. Results are shown in Table 13, which shows the composition by weight that is initially charged to vessel, the composition by weight in vapor phase initially and after 50% of the overall composition has leaked from the vessel, and the pressure is reported as % difference between the initial pressure and after the 50% leak.

TABLE 13

| Charged | | | | Initial Vapor | | | | After 50% Leak | | | | |
|---|---|---|---|---|---|---|---|---|---|---|---|---|
| R-1234-yf | R-32 | R-134a | R-125 | R-1234-yf | R-32 | R-134a | R-125 | R-1234-yf | R-32 | R-134a | R-125 | |
| % | % | % | % | % | % | % | % | % | % | % | % | P-% diff |
| 50 | 15 | 5 | 30 | 38 | 22 | 4 | 35 | 46 | 16 | 5 | 33 | −9 |
| 45 | 15 | 5 | 35 | 35 | 22 | 4 | 40 | 41 | 16 | 5 | 38 | −8 |
| 40 | 15 | 5 | 40 | 31 | 21 | 3 | 45 | 37 | 16 | 5 | 42 | −7 |
| 45 | 15 | 15 | 25 | 36 | 23 | 11 | 30 | 43 | 16 | 14 | 27 | −9 |
| 40 | 15 | 15 | 30 | 32 | 22 | 10 | 35 | 38 | 16 | 14 | 32 | −8 |
| 50 | 25 | 5 | 20 | 39 | 35 | 3 | 23 | 46 | 26 | 5 | 21 | −8 |
| 45 | 25 | 5 | 25 | 35 | 34 | 3 | 28 | 41 | 27 | 5 | 27 | −7 |
| 40 | 25 | 5 | 30 | 31 | 33 | 3 | 33 | 37 | 27 | 4 | 32 | −6 |
| 35 | 25 | 5 | 35 | 27 | 32 | 3 | 38 | 32 | 27 | 4 | 37 | −5 |
| 30 | 25 | 5 | 40 | 23 | 31 | 3 | 42 | 28 | 27 | 4 | 41 | −5 |
| 55 | 25 | 15 | 5 | 45 | 37 | 11 | 6 | 52 | 28 | 15 | 5 | −10 |
| 50 | 25 | 15 | 10 | 41 | 36 | 11 | 12 | 47 | 28 | 14 | 11 | −9 |
| 45 | 25 | 15 | 15 | 36 | 35 | 11 | 18 | 43 | 27 | 14 | 16 | −9 |
| 40 | 25 | 15 | 20 | 33 | 34 | 10 | 23 | 38 | 27 | 14 | 21 | −10 |
| 35 | 25 | 15 | 25 | 28 | 33 | 10 | 28 | 33 | 27 | 13 | 26 | −7 |
| 30 | 25 | 15 | 30 | 24 | 33 | 10 | 33 | 28 | 27 | 13 | 31 | −6 |
| 25 | 25 | 15 | 35 | 20 | 32 | 10 | 38 | 24 | 27 | 13 | 36 | −6 |
| 45 | 25 | 25 | 5 | 39 | 37 | 18 | 6 | 44 | 27 | 24 | 5 | −9 |
| 40 | 25 | 25 | 10 | 34 | 36 | 18 | 12 | 39 | 27 | 23 | 11 | −9 |
| 35 | 25 | 25 | 15 | 30 | 35 | 17 | 18 | 34 | 27 | 23 | 16 | −8 |
| 30 | 25 | 25 | 20 | 26 | 34 | 17 | 23 | 29 | 27 | 22 | 21 | −8 |
| 25 | 25 | 25 | 25 | 21 | 33 | 17 | 29 | 24 | 27 | 22 | 26 | −7 |
| 20 | 25 | 25 | 30 | 17 | 33 | 16 | 34 | 20 | 26 | 22 | 32 | −8 |
| 15 | 25 | 25 | 35 | 13 | 32 | 16 | 39 | 15 | 27 | 22 | 37 | −7 |
| 35 | 25 | 35 | 5 | 32 | 37 | 25 | 6 | 35 | 27 | 33 | 5 | −9 |
| 30 | 25 | 35 | 10 | 27 | 36 | 25 | 12 | 30 | 27 | 32 | 11 | −9 |
| 25 | 25 | 35 | 15 | 23 | 35 | 24 | 18 | 25 | 27 | 32 | 16 | −9 |
| 20 | 25 | 35 | 20 | 18 | 34 | 24 | 24 | 20 | 27 | 32 | 21 | −8 |
| 15 | 25 | 35 | 25 | 14 | 34 | 23 | 29 | 15 | 27 | 31 | 27 | −8 |
| 10 | 25 | 35 | 30 | 9 | 33 | 23 | 35 | 10 | 27 | 31 | 32 | −8 |
| 5 | 25 | 35 | 35 | 5 | 32 | 23 | 40 | 5 | 27 | 31 | 37 | −8 |
| 10 | 25 | 30 | 35 | 9 | 32 | 19 | 39 | 10 | 27 | 26 | 37 | −8 |
| 20 | 25 | 20 | 35 | 17 | 32 | 13 | 38 | 19 | 27 | 17 | 37 | −6 |
| 30 | 25 | 10 | 35 | 24 | 32 | 6 | 38 | 28 | 27 | 9 | 36 | −6 |
| 25 | 25 | 45 | 5 | 24 | 37 | 33 | 6 | 26 | 27 | 42 | 5 | −10 |
| 20 | 25 | 45 | 10 | 19 | 36 | 32 | 13 | 21 | 27 | 41 | 11 | −10 |
| 15 | 25 | 45 | 15 | 15 | 35 | 31 | 19 | 16 | 27 | 41 | 16 | −10 |
| 10 | 25 | 45 | 20 | 10 | 35 | 31 | 24 | 10 | 27 | 41 | 22 | −10 |
| 5 | 25 | 45 | 25 | 5 | 34 | 30 | 31 | 5 | 27 | 41 | 27 | −10 |
| 10 | 25 | 50 | 15 | 10 | 36 | 35 | 20 | 11 | 27 | 46 | 16 | −11 |
| 15 | 20 | 50 | 15 | 15 | 30 | 36 | 19 | 16 | 22 | 46 | 16 | −11 |
| 20 | 15 | 50 | 15 | 20 | 23 | 37 | 20 | 21 | 16 | 47 | 16 | −11 |
| 22 | 21 | 32 | 25 | 20 | 29 | 22 | 30 | 22 | 23 | 29 | 26 | −9 |
| 25 | 23 | 27 | 25 | 22 | 31 | 18 | 29 | 25 | 25 | 24 | 26 | −8 |
| 27 | 23 | 25 | 25 | 23 | 31 | 17 | 29 | 26 | 25 | 22 | 27 | −8 |
| 32 | 23 | 20 | 25 | 27 | 31 | 13 | 29 | 31 | 25 | 18 | 26 | −8 |
| 15 | 20 | 35 | 30 | 14 | 27 | 24 | 35 | 15 | 22 | 31 | 32 | −9 |
| 15 | 20 | 30 | 35 | 13 | 27 | 20 | 40 | 15 | 22 | 26 | 37 | −8 |
| 20 | 20 | 25 | 35 | 17 | 27 | 16 | 40 | 20 | 21 | 22 | 37 | −7 |
| 25 | 20 | 20 | 35 | 21 | 27 | 13 | 40 | 24 | 21 | 18 | 37 | −7 |
| 30 | 20 | 15 | 35 | 24 | 27 | 10 | 39 | 28 | 22 | 13 | 37 | −7 |
| 20 | 25 | 30 | 25 | 18 | 33 | 20 | 29 | 20 | 27 | 27 | 26 | −8 |
| 30 | 25 | 20 | 25 | 25 | 33 | 13 | 28 | 29 | 27 | 18 | 26 | −7 |
| 10 | 30 | 30 | 30 | 9 | 38 | 19 | 34 | 10 | 32 | 26 | 32 | −7 |
| 15 | 30 | 25 | 30 | 13 | 38 | 16 | 33 | 15 | 32 | 22 | 31 | −7 |
| 20 | 30 | 20 | 30 | 17 | 37 | 13 | 33 | 19 | 32 | 17 | 31 | −6 |
| 22 | 30 | 18 | 30 | 18 | 38 | 11 | 33 | 21 | 32 | 16 | 31 | −6 |
| 25 | 30 | 15 | 30 | 20 | 37 | 10 | 33 | 24 | 32 | 13 | 31 | −6 |
| 20 | 40 | 15 | 25 | 17 | 47 | 9 | 27 | 19 | 42 | 13 | 26 | −5 |
| 15 | 40 | 15 | 30 | 12 | 47 | 9 | 32 | 14 | 42 | 13 | 31 | −4 |
| 15 | 40 | 25 | 20 | 13 | 49 | 16 | 22 | 15 | 43 | 21 | 21 | −6 |
| 10 | 40 | 25 | 25 | 9 | 48 | 15 | 28 | 10 | 43 | 21 | 26 | −6 |
| 5 | 40 | 25 | 30 | 4 | 48 | 15 | 33 | 5 | 43 | 21 | 31 | −6 |
| 10 | 40 | 35 | 15 | 9 | 51 | 22 | 18 | 10 | 43 | 31 | 16 | −8 |
| 5 | 40 | 35 | 20 | 5 | 50 | 22 | 23 | 5 | 43 | 31 | 21 | −8 |
| 30 | 20 | 10 | 40 | 24 | 26 | 7 | 43 | 28 | 21 | 9 | 42 | −6 |
| 25 | 20 | 15 | 40 | 20 | 26 | 10 | 44 | 24 | 21 | 13 | 42 | −6 |
| 20 | 20 | 20 | 40 | 17 | 26 | 13 | 44 | 19 | 21 | 17 | 42 | −7 |
| 15 | 20 | 25 | 40 | 13 | 26 | 16 | 45 | 15 | 21 | 22 | 42 | −7 |
| 10 | 20 | 30 | 40 | 9 | 26 | 20 | 45 | 10 | 22 | 26 | 42 | −8 |
| 5 | 20 | 35 | 40 | 5 | 26 | 23 | 46 | 5 | 22 | 31 | 42 | −8 |

1. A heat transfer composition comprising difluoromethane, pentafluoroethane, 1,1,1,2-tetrafluoroethane, and 2,3,3,3-tetrafluoropropene.

2. The heat transfer composition of claim 1 comprising from 1% to 97% difluoromethane, from 1% to 97% pentafluoroethane, from 1% to 97% 1,1,1,2-tetrafluoroethane, and from 1% to 97% 2,3,3,3-tetrafluoropropene on a weight basis.

3. The heat transfer composition of claim 1 comprising from about 10% to 35% difluoromethane, from about 10% to 35% pentafluoroethane, from about 10% to 60% 1,1,1,2-tetrafluoroethane and from about 10% to 60% 2,3,3,3-tetrafluoropropene on a weight basis.

4. The heat transfer composition of claim 1 comprising from about 15% to 30% difluoromethane, from about 15% to 30% pentafluoroethane, from about 15% to 40% 1,1,1,2-tetrafluoroethane and from about 15% to 40% 2,3,3,3-tetrafluoropropene on a weight basis.

5. The heat transfer composition of claim 1 comprising less than about 40 wt % pentafluoroethane and greater than about 10 wt % 2,3,3,3-tetrafluoropropene.

6. The heat transfer composition of claim 1 comprising less than about 30 wt % pentafluoroethane and greater than about 20 wt % 2,3,3,3-tetrafluoropropene.

7. The heat transfer composition of claim 1 comprising about 5% to 40% by weight of difluoromethane and greater than about 10% by weight of 2,3,3,3-tetrafluoropropene.

8. The heat transfer composition of claim 1 comprising about 10% to 30% by weight of difluoromethane and greater than about 20% by weight of 2,3,3,3-tetrafluoropropene.

9. The heat transfer composition of claim 1 wherein the combined wt % of difluoromethane and pentafluoroethane is from 2% to 98% and the combined wt % of 1,1,1,2-tetrafluoroethane and 2,3,3,3-tetrafluoropropene is from about 98% to 2%.

10. The heat transfer composition of claim 1 wherein the combined wt % of difluoromethane and pentafluoroethane is from 25% to 70% and the combined wt % of 1,1,1,2-tetrafluoroethane and 2,3,3,3-tetrafluoropropene is from about 75% to 30%.

11. The heat transfer composition of claim 1 wherein the combined wt % of difluoromethane and pentafluoroethane is from 35% to 60% and the combined wt % of 1,1,1,2-tetrafluoroethane and 2,3,3,3-tetrafluoropropene is from about 65% to 40%.

12. The heat transfer composition of claim 1 where the ratio of difluoromethane to pentafluoroethane is from about 1:2 to about 2:1 on a weight basis.

13. The heat transfer composition of claim 1 where the ratio of difluoromethane to pentafluoroethane is from about 1:2 to about 1:1 on a weight basis.

14. The heat transfer composition of claim 1 where the ratio of 1,1,1,2-tetrafluoroethane to 2,3,3,3-tetrafluoropropene is from about 1:2 to about 2:1 on a weight basis.

15. The heat transfer composition of claim 1 comprising from about 5% to 40% difluoromethane on a weight basis.

16. The heat transfer composition of claim 1 comprising from about 10% to 30% difluoromethane on a weight basis.

17. The heat transfer composition of claim 1 comprising from about 10% to 35% difluoromethane, from about 10% to 35% pentafluoroethane, from about 10% to 60% 1,1,1,2-tetrafluoroethane, and from about 10% to 60% 2,3,3,3-tetrafluoropropene on a weight basis.

18. The heat transfer composition of claim 1 comprising from about 15% to 30% difluoromethane, from about 15% to 30% pentafluoroethane, from about 15% to 40% 2,3,3,3-tetrafluoropropene and from about 15% to 40% 1,1,1,2-tetrafluoroethane on a weight basis.

19. The heat transfer composition of claim 1 comprising from about 15% to 30% difluoromethane, from about 15% to 30% pentafluoroethane, from about 25% to about 40% 1,1,1,2-tetrafluoroethane, and from about 15% to 40% 2,3,3,3-tetrafluoropropene on a weight basis.

20. The heat transfer composition of claim 1 comprising from about 15% to 25% difluoromethane, from about 20% to 30% pentafluoroethane, from about 10% to about 40% 1,1,1,2-tetrafluoroethane, and from about 10% to 40% 2,3,3,3-tetrafluoropropene on a weight basis.

21. The heat transfer composition of claim 1 comprising from about 25% to 60% by weight of the combination of difluoromethane and 2,3,3,3-tetrafluoropropene.

22. The heat transfer composition of claim 1 further comprising a hydro fluorocarbon, hydrochlorofluorocarbon, hydrofluoroolefin, fluorinated cyclopropane, fluorinated methyl cylcopropane, hydrofluorochlorocarbon, hydrocarbon, hydrofluoroether, fluoroketone, chlorofluorocarbon, trans-1,2-dichloroethylene, carbon dioxide, ammonia, dimethyl ether, and mixtures thereof.

23. The heat transfer composition of claim 1 further comprising a lubricant.

24. The heat transfer composition of claim 23 where the lubricant is selected from polyol ester oils, polyglycols, polyalkylene glycols, polyvinyl ethers, mineral oils, alkyl benzene oils, polyalpha olefins, and mixtures thereof.

25. The heat transfer composition of claim 23 where the lubricant is selected from polyol ester oils, mineral oils, alkyl benzene oils, and mixtures thereof.

26. A sprayable composition comprising the heat transfer composition of claim 1.

27. A blowing agent composition comprising the heat transfer composition of claim 1.

28. A polymer foam made using the blowing agent of claim 27.

29. A propellant composition comprising the heat transfer composition of claim 1.

30. An aerosol composition comprising the heat transfer composition of claim 1.
